(19) United States
(12) Patent Application Publication
(10) Pub. No.: US 2008/0210584 A1
(43) Pub. Date: Sep. 4, 2008

(54) FIBER-CAST PACKAGING WITH INNER BAG AND METHOD FOR THE PRODUCTION THEREOF

(75) Inventors: Wolfgang Barthel, Langenfeld (DE); Salvatore Fileccia, Oberhausen (DE)

Correspondence Address: Ratner Prestia, Suite 301, 1235 Westlakes Drive, Berwyn, PA, 19312, US

(73) Assignee: Henkel Kommanditgesellschaft Auf Aktien, Dusseldorf (DE)

(21) Appl. No.: 12/098,717

(22) Filed: Apr. 7, 2008

Related U.S. Application Data
(63) Continuation of application No. PCT/EP2006/008864, filed on Sep. 12, 2006.

(30) Foreign Application Priority Data
Oct. 6, 2005 (DE) 10 2005 048 182.5

(51) Int. Cl. B65D 77/06; B65D 1/22; B29C 39/10

(52) U.S. Cl. 206/216; 206/581; 264/257; 229/406

(57) ABSTRACT

A package for free-flowing media comprising a molded pulp vessel partly or completely surrounding two or more film pouches or a film pouch having a plurality of chambers. An environmentally friendly package whose constituents can be reused without any great complexity.

### CROSS-REFERENCE TO RELATED APPLICATIONS

This application is a continuation under 35 U.S.C. §§ 120 and 365(c) of international application PCT/EP2006/008864, filed on Sep. 12, 2006. This application also claims priority under 35 U.S.C. § 119 of DE 10 2005 048 182.5, filed on Oct. 6, 2005.

### BACKGROUND OF THE INVENTION

The present invention relates to a package for free-flowing media and to a process for producing such a package.

Washing compositions, cleaning compositions, care compositions, pretreatment or aftertreatment compositions, and also foods and cosmetics, are nowadays available to the consumer in a wide variety of supply forms. In addition to solid compositions such as powders, granules, and coated and uncoated tablets, free-flowing compositions in particular, and among these especially gel-form and liquid compositions, are enjoying wide acceptance among consumers.

Solid media are supplied either in portioned, individually packaged units or in large containers, from which the consumer can take the amount required each time. Such vessels often consist of plastics or cardboard and are in some cases coated against the action of moisture.

Comparable packages are also used for the portioning of free-flowing media. Especially in the case of liquid and gel-form contents, cardboard packages are preferably coated with a water-insoluble material on the inside. The stability of such packaged units is formed by the plastic or cardboard envelope, while the coating serves merely for protection against saturation and soaking through the cardboard. A known example of corresponding cardboard packages is that of the so-called Tetra-Paks.

The disadvantages of such vessels consist mainly in that, to produce the packages, numerous working steps are needed, large amounts of cellulose fibers are required to provide dimensionally stable vessels, and complete coating of the vessel inner walls has to be ensured. In these vessels, the coating material is adhesive-bonded to all walls.

The most important disadvantage of plastic vessels for the packaging of free-flowing media is the expense of the production process, which arises principally through the need for specific molds to be used for the molding of the plastic materials and for the vessel material to be softened before the shaping, which can be achieved only through the supply of energy.

Just like the use of slow-degrading or nondegradable plastic material, the great need for cellulose fibers for cardboard vessels is a serious disadvantage of the known packages, especially in view of growing environmental awareness. An additional problem with coated cardboard packages is that the film can be separated only with unacceptably great effort, if at all, from the recyclable cardboard constituents of the package, which makes consistent ecological disposal of the emptied packages impossible.

It was an object of the present invention to solve the above problems of known packages for free-flowing and especially liquid and gel-form media. There was a particular interest in producing very environmentally friendly packages whose constituents can be reused without any great complexity.

This object has been achieved by providing a package for free-flowing media which consists of a molded pulp vessel which comprises one or more film pouches.

### BRIEF DESCRIPTION OF THE DRAWINGS

FIG. 1 is a perspective view of a package according to the present invention showing the outer molded pulp vessel and the inner film pouch.

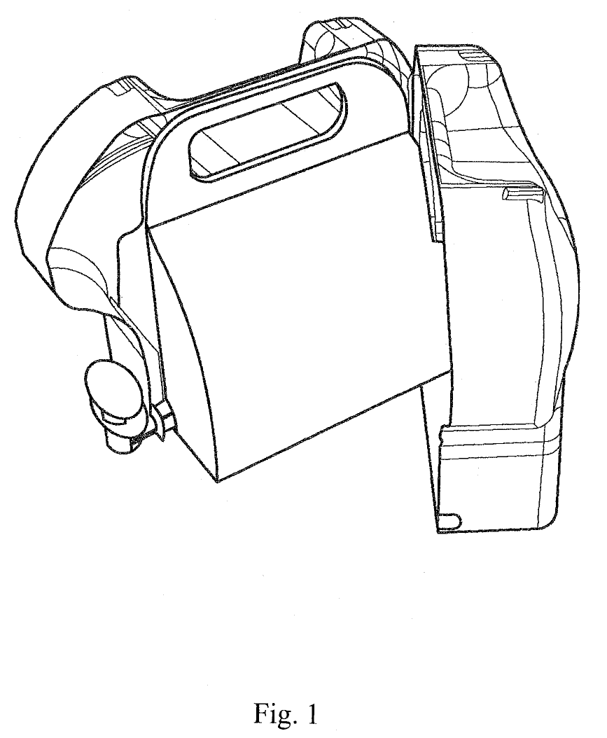

### DESCRIPTION OF THE INVENTION

The present application provides a package for free-flowing media comprising a molded pulp vessel and a film pouch partly or completely surrounded by this molded pulp vessel.

In the context of this application, free-flowing media are gel-form, liquid and particulate media such as powders and granules. Preference is given to using the inventive vessel for liquids and gels, especially for liquids.

A molded pulp vessel in the context of the application is a vessel which is produced by molding and drying a suspension of fibers. The customary package of eggs, the eggbox, is probably the best known example of a molded pulp vessel.

The fibers used for the molded pulp vessel are preferably fibrous materials whose main source is wood. As well as mechanical pulp, chemical pulp can be used.

According to the principal processes employed, pulp is divided into sulfate pulp and sulfite pulp, and rarely also soda pulp. The semichemical pulp obtained in a combined chemical-mechanical process, in terms of its properties and usability for the production of molded pulp vessels, is between mechanical pulp and chemical pulp.

Further raw material sources of minor importance for molded pulp vessels may be cereal straw, esparto grass, bagasse (residues from sugar production), linters (short fibers from cotton) or else textile wastes (rags). Also usable are synthetic fibers, and according to the end use also mineral fibers. In the context of the present invention, particular preference is given to the use of waste paper.

Waste paper in the context of this application is paper and paperboard which has already been used, i.e. which has already been used, for example, as a newspaper, magazine, book, brochure, cardboard package or in another form and has been returned by the consumer for recycling. This waste paper accordingly consists not only of cellulose-containing fibers but additionally comprises fillers for improving smoothness, printability and opacity, dyes and pigments from the inking of the paper stock and printing inks, binders for sizing the paper, optical brighteners for increasing the whiteness and retention aids, in proportions varying in each case.

In addition, the term “waste paper” is understood to mean material returned from production or processing, which has not yet been used by the consumer but has not been delivered to the consumer owing to overproduction, production faults or the like. The use of waste paper protects resources (pulp) and additionally leads to reduced pollution of the air and wastewater in the production of inventive vessels.

The inventive molded pulp vessel preferably consists of cellulose-containing fibers to an extent of at least 50% by weight, preferably to an extent of at least 60% by weight, more preferably to an extent of at least 70% by weight, more preferably to an extent of at least 80% by weight, with preference to an extent of at least 90% by weight and especially to an extent of at least 95% by weight. For ecological reasons, it is particularly preferred in this context when the molded pulp vessel consists of waste paper to an extent of at least 50% by weight, preferably to an extent of at least 60% by weight, more preferably to an extent of at least 70% by weight, more preferably to an extent of at least 80% by weight, with preference to an extent of at least 90% by weight and especially to an extent of at least 95% by weight.

In addition to the fibers, the molded pulp vessel may comprise nonfibrous feedstocks, known as assistants. The most important assistants include fillers such as kaolin, chalk or titanium dioxide, dyes and pigments for inking the molded pulp material or for surface dyeing, binders such as starch, casein and other proteins, polymer dispersions, resin sizes for consolidating the fiber structure, binding of fillers and pigments and increasing the water resistance, optical brighteners for increasing the whiteness, retention aids such as aluminum sulfate or synthetic cationic substances for retaining the fine substances and fillers during the production of the molded pulp vessel, deinking chemicals for the processing of waste paper, and various other substances such as wetting agents, defoamers, preservatives, slime control agents, plasticizers, antiblocking agents, antistats, flame retardants and/or hydrophobizing agents.

According to the invention, the package comprises at least one film pouch. This film pouch is preferably water-insoluble and preferably consists of water-insoluble polymers and/or polymer mixtures.

In the context of the present application, the term “polymers” is understood to mean addition polymers, polyadducts and polycondensates.

Addition polymers refer to those high molecular weight compounds whose formation proceeds by a chain growth mechanism. Preferred polymers in the context of the present application are polyethylene, polypropylene, poly-1-butene, poly-4-methyl-1-pentene, polyvinyl chloride, polyvinylidene chloride, polyacrylonitrile and/or polystyrene.

Polyadducts are formed through polyaddition, i.e. poly reactions, in which repeating and mutually independent linkage reactions of bis- or polyfunctional reactants (monomers), via reactive oligomers, finally form polymers. Preferred polyadducts are polyurethanes.

Like the polyadducts, polycondensates form through repeating and mutually independent linkage reactions of discrete oligomers and monomers, except that, in contrast to the polyaddition, elimination of low molecular weight compounds proceeds simultaneously. Preferred polycondensates in the context of the present invention are polyamides, polycarbonates and polyesters.

Plastics are notable for particular versatility, especially with regard to their processability. It is just as possible to process plastics by extrusion or injection molding methods as it is to process them by drawing methods. In the case of drawing (thermoforming), a preheated plastic slab or film is introduced between the two parts of the mold, the positive and the negative, which are then forced together, as a result of which the plastic part receives its shape. Cold working proceeds in a similar way; here, however, the slab or film to be deformed is not preheated. When no negative mold is present, reference is made to deep-drawing.

Irrespective of the type of shaping process, a preferred film pouch, depending on the material used, has a wall thickness between 5 μm and 2000 μm, preferably between 10 μm and 1000 μm and especially between 50 μm and 500 μm.

In order to increase the stability (e.g. breaking strength), to reduce the permeability or else to improve the outward appearance of the film pouch, it can be provided with a deposited metal or be bonded to a metal foil.

For visual assessment, it may also be preferred to print on the film pouch(es).

When the film pouch(es) is/are surrounded by the molded pulp vessel to an extent of at least 75% by volume, it is preferred that the film pouch(es) is/are not printed.

Preferably, the film pouch(es) is or are transparent or translucent and enable(s) the consumer to see the individual media through the pouch wall. In the context of this invention, transparency is understood to mean that the transmittance within the visible spectrum of light (from 410 to 800 nm) is greater than 20%, preferably greater than 30%, exceptionally preferably greater than 40% and especially greater than 50%. As soon as one wavelength in the visible spectrum of light has a transmittance greater than 20%, it should be considered to be transparent in the context of the invention. According to the degree to which the film pouch(es) is/are enveloped by the molded pulp vessel, it is relatively unimportant to use a transparent or translucent film pouch material. Especially in the case in which the film pouch(es) is/are enveloped by the molded pulp vessel to an extent of at least 75% by volume, based on the sum of the film pouches, preference is given to using a film pouch material which has a light transmittance of less than 20% according to the above definition.

In a preferred embodiment, the molded pulp vessel has one, two or more viewing windows which may optionally be sealed with a transparent film, and the film pouch(es) is/are translucent or transparent according to the above definition. This configuration is particularly advantageous, since it is possible in this way, even in the case of virtual or complete surrounding of the film pouch(es) by the molded pulp vessel, to recognize the fill level of the medium or media through the viewing window(s).

For selected application sectors or fillings, it may be preferable that the film pouch is not permeable for the free-flowing medium present in the pouch (or the solvent present therein), but is water-soluble or water-dispersible. Such a configuration is of particular interest with regard to easy separability of molded pulp vessel and film pouch, since the film pouch here, for example, in the case of sufficiently high moisture stability of the molded pulp vessel can be removed from the vessel, such that simple separation of the package into reusable waste paper and film pouch materials can be effected. Alternatively, in the case of use of a molded pulp vessel with low moisture stability, it is possible to dissolve or to disperse the entire emptied package, i.e. the molded pulp vessel and the film pouch(es), in water, and to remove the fibers from the molded pulp vessel from the aqueous solution for reuse. This configuration is particularly preferred in the case of use of cellulose-containing film pouches, since the totality of cellulose fibers from cellulose fiber-containing molded pulp vessels and cellulose-containing film pouches can be reused in this case.

These configurations are of particular interest for film pouches which are filled with free-flowing particulate media.

Suitable materials for water-soluble or water-dispersible film pouches are known from the prior art and originate, for example, from the group of (acetalized) polyvinyl alcohol, polyvinylpyrrolidone, polyethylene oxide, gelatins and mixtures thereof.

Particularly preferred packages are characterized in that the water-soluble or water-dispersible film pouch comprises one or more water-soluble polymer(s), preferably a material from the group of (optionally acetalized) polyvinyl alcohol (PVAL), polyvinylpyrrolidone, polyethylene oxide, gelatin, cellulose, and derivatives thereof and mixtures thereof.

“Polyvinyl alcohols” (abbreviation PVAL, occasionally also PVOH) is the name for polymers of the general structure

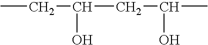

which also comprise structural units of the

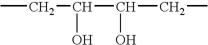

type in small fractions (approx. 2%).

Commercial polyvinyl alcohols, which are supplied as white-yellowish powders or granules with degrees of polymerization in the range from approx. 100 to 2500 (molar masses from approx. 4000 to 100 000 g/mol), have degrees of hydrolysis of 98-99 or 87-89 mol %, and thus also comprise a residual content of acetyl groups. The polyvinyl alcohols are characterized on the part of the manufacturer by specifying the degree of polymerization of the starting polymer, the degree of hydrolysis, the hydrolysis number or the solution viscosity.

Depending on the degree of hydrolysis, polyvinyl alcohols are soluble in water and a few strongly polar organic solvents (formamide, dimethylformamide, dimethyl sulfoxide); they are not attacked by (chlorinated) hydrocarbons, esters, fats and oils. Polyvinyl alcohols are classified as toxicologically safe and are at least partially biodegradable. The water solubility can be reduced by aftertreatment with aldehydes (acetalization), by complexing with nickel or copper salts or by treatment with dichromates, boric acid or borax. The coatings made of polyvinyl alcohol are largely impenetrable to gases such as oxygen, nitrogen, helium, hydrogen, carbon dioxide, but allow steam to pass through.

In the context of the present invention, it is preferred that the water-soluble or water-dispersible film pouch comprises a polyvinyl alcohol whose degree of hydrolysis is from 70 to 100 mol %, preferably from 80 to 90 mol %, more preferably from 81 to 89 mol % and in particular from 82 to 88 mol %.

The materials used for the vessels are preferably polyvinyl alcohols of a particular molecular weight range, preference being given in accordance with the invention to the water-soluble or water-dispersible film pouch comprising a polyvinyl alcohol whose molecular weight is in the range from 10 000 to 100 000 gmol⁻¹, preferably from 11 000 to 90 000 gmol⁻¹, more preferably from 12 000 to 80 000 gmol⁻¹ and in particular from 13 000 to 70 000 gmol⁻¹.

The degree of polymerization of such preferred polyvinyl alcohols is between about 200 and about 2100, preferably between about 220 and about 1890, more preferably between about 240 and about 1680 and in particular between about 260 and about 1500.

The polyvinyl alcohols described above are widely available commercially, for example under the trade name Mowiol® (Clariant). Polyvinyl alcohols which are particularly suitable in the context of the present invention are, for example, Mowiol® 3-83, Mowiol® 4-88, Mowiol® 5-88 and Mowiol® 8-88.

Further polyvinyl alcohols which are particularly suitable for the film pouch can be taken from the table below:

| | Degree of | Molar mass | Melting point |
|---|---|---|---|
| Name | hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable for the film pouch are ELVANOL® 51-05, 52-22, 50-42, 85-82, 75-15, T-25, T-66, 90-50 (trademark of Du Pont), ALCOTEX® 72.5, 78, B72, F80/40, F88/4, F88/26, F88/40, F88/47 (trademark of Harlow Chemical Co.), Gohsenol® NK-05, A-300, AH-22, Q-500, GH-20, GL-03, GM-14L, KA-20, KA-500, KH-20, KP-06, N-300, NH-26, NM11Q, KZ-06 (trademark of Nippon Gohsei K.K.).

The water solubility of PVAL can be altered by aftertreatment with aldehydes (acetalization) or ketones (ketalization). In this context, particularly preferred polyvinyl alcohols which are particularly advantageous due to their exceptionally good solubility in cold water have been found to be those which are acetalized or ketalized with the aldehyde and keto groups, respectively, of saccharides or polysaccharides or mixtures thereof. The reaction products of PVAL and starch can be used exceptionally advantageously.

Examples of suitable water-soluble PVAL films are the PVAL films obtainable under the name “SOLUBLON®” from Syntana Handelsgesellschaft E. Harke GmbH & Co. Their solubility in water can be adjusted to a precise degree, and films of this product series are obtainable which are soluble in the aqueous phase in all temperature ranges relevant for the application.

Polyvinylpyrrolidones, referred to for short as PVP, can be described by the following general formula:

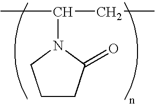

PVPs are prepared by free-radical polymerization of 1-vinylpyrrolidone. Commercially available PVPs have molar masses in the range from approx. 2500 to 750 000 g/mol and are supplied as white, hygroscopic powders or as aqueous solutions.

Polyethylene oxides, PEOX for short, are polyalkylene glycols of the general formula

H—[O—CH₂—CH₂]ₙ—OH

which are prepared industrially by base-catalyzed polyaddition of ethylene oxide (oxirane) in systems containing usually small amounts of water, with ethylene glycol as the starter molecule. They have molar masses in the range from about 200 to 5 000 000 g/mol, corresponding to degrees of polymerization n of from about 5 to >100 000. Polyethylene oxides have an exceptionally low concentration of reactive hydroxyl end groups and exhibit only weak glycol properties.

Gelatin is a polypeptide (molar mass: from approx. 15 000 to >250 000 g/mol) which is obtained primarily by hydrolysis of the collagen present in skin and bones of animals under acidic or alkaline conditions. The amino acid composition of the gelatin corresponds substantially to that of the collagen from which it has been obtained and varies depending on its provenance. The use of gelatin as a water-soluble envelope material is widespread, especially in pharmacy, in the form of hard or soft gelatin capsules. In the form of films, gelatin only finds use to a minor degree owing to its high cost compared to the aforementioned polymers.

In the context of the present invention, preference is also given to inventive packages whose film pouch consists at least partly of water-soluble film composed of at least one polymer from the group of starch and starch derivatives, cellulose and cellulose derivatives, in particular methylcellulose, and mixtures thereof.

Starch is a homoglycan, the glucose units being linked α-glycosidically. Starch is made up of two components of different molecular weight: of from approx. 20 to 30% of straight-chain amylose (MW from approx. 50 000 to 150 000) and from 70 to 80% of branched-chain amylopectin (MW from approx. 300 000 to 2 000 000). In addition, small amounts of lipids, phosphoric acid and cations are also present. While the amylose forms long, helical, intertwined chains having from approx. 300 to 1200 glucose molecules owing to the binding in the 1,4-arrangement, the chain branches in the case of amylopectin after, on average, 25 glucose units by a 1,6-bond to give a branch-like structure having from about 1500 to 12 000 molecules of glucose. In addition to pure starch, suitable substances for the production of the film pouches are also starch derivatives which are obtainable from starch by polymer-like reactions. Such chemically modified starches include, for example, products of esterifications or etherifications in which hydroxyl hydrogen atoms have been substituted. However, starches in which the hydroxyl groups have been replaced by functional groups which are not bonded via an oxygen atom can also be used as starch derivatives. The group of starch derivatives includes, for example, alkali metal starches, carboxymethyl starch (CMS), starch esters and starch ethers, and also amino starches.

Pure cellulose has the formal gross composition (C₆H₁₀O₅)ₙ and, considered in a formal sense, constitutes a β-1,4-polyacetal of cellobiose which is itself formed from two molecules of glucose. Suitable celluloses consist of from approx. 500 to 5000 glucose units and accordingly have average molar masses of from 50 000 to 500 000. Suitable film pouch materials in the context of the present invention also include cellulose derivatives which are obtainable from cellulose by polymer-like reactions. Such chemically modified celluloses comprise, for example, products of esterifications or etherifications in which hydroxyl hydrogen atoms have been substituted. However, celluloses in which the hydroxyl groups have been replaced by functional groups which are not bonded via an oxygen atom can also be used as cellulose derivatives. The group of cellulose derivatives includes, for example, alkali metal celluloses, carboxymethylcellulose (CMC), cellulose esters and cellulose ethers, and also aminocelluloses.

The use of cellulose (derivatives) as a film pouch constituent is particularly preferred.

According to the end use or filling, it may be preferable that the molded pulp vessel comprises a plurality of different, possibly even mutually incompatible, free-flowing media/compositions. In order to ensure separation of the media during storage and transport, it may be preferable that the molded pulp vessel encloses a plurality of film pouches and/or that the surrounded film pouch(es) has/have a plurality of chambers.

In a preferred embodiment, the molded pulp vessel encloses 2, 3, 4 or 5 film pouches partly or completely.

In a further preferred embodiment, the film pouch(es) has/have n chambers and is/are filled with n, n−1 or n−2 different media, preferably liquids, where n is 1, 2, 3, 4 or 5.

In the context of the application, a film pouch surrounded partly by the molded pulp vessel is understood to mean either an embodiment in which only one, two or three corners and/or edges of the film pouch(es) are not surrounded by the molded pulp vessel, or else, for example, an embodiment in which the film pouch(es) is/are from 10 to up to 95% by volume, up to 90% by volume, up to 85% by volume, up to 80% by volume, up to 75% by volume, up to 70% by volume, up to 65% by volume, up to 60% by volume, up to 55% by volume, up to 50% by volume, up to 45% by volume, up to 40% by volume, or even only from 10 up to 20% by volume, based on the volume of the totality of the film pouches present, surrounded by the molded pulp vessel. In a preferred embodiment, one or more film pouch(es) lie(s) in the molded pulp vessel as in a basket and are visible from outside the molded pulp vessel to an extent of at least ⅙, preferably to an extent of at least ⅕, more preferably to an extent of at least ¼, more preferably to an extent of at least ⅓, with preference to an extent of at least ½, more preferably to an extent of at least ⅔, preferably to an extent of at least ¾.

However, it is very particularly preferred when the molded pulp vessel virtually completely surrounds the film pouch(es) and only part of the surface, for example a corner of the film pouch(es), is visible from the outside. This part of the surface or corner can be cut into with a knife or scissors or even torn into, in order to release the filling, preferably by pouring it out. It is also preferred that the film pouch(es) is/are surrounded completely by the molded pulp vessel and that the consumer also opens the film pouch(es) by cutting into, cutting off, tearing into or tearing off a part of the area or corner or edge of the molded pulp vessel. Suitable cutting lines are preferably marked so as to be visible on the vessel material. In order to withdraw the contents of the film pouch(es), it may be preferred, instead of the above-described cutting-open or tearing-open of the pouch, in a further embodiment of the invention, when the pouch can be punctured with a withdrawal device, for example a dosage tap, and the contents of the pouch can thus be withdrawn in a dosed manner. The withdrawal device is preferably reusable, i.e. it can be removed again and used again in another way. Without leaving the scope of the invention, it is possible for a person skilled in the art, with the aid of his or her routine knowledge, for example, to select suitable withdrawal devices and pouch materials which ensure a sufficiently stable hold of the withdrawal device for the duration of its residence on or in the film pouch with prevention of leakage. In a particular embodiment, the opening is effected with the withdrawal device in the manner known from bunghole beer kegs. In this case, the tap—which corresponds to the withdrawal device—is introduced into a bunghole of the beer keg, in which case the tap bears a collar of an elastic material such as rubber for a reliable and sealing hold in the region of the bunghole. By knocking the tap in completely, a membrane is punctured and a liquid connection between vat and tap is created. Applied to the present invention, the molded pulp vessel may have an opening which gives access to the film pouch and whose wall can be reinforced for reliable accommodation of a withdrawal device.

The film pouch(es) preferable open(s) in a common dosage closure or dosage tap or a plurality of separate dosage closures or dosage taps, which are especially connected to the film pouch(es) in a releasable manner.

The dosage closures may be reclosable by a flip-top closure, snap closure, adhesive closure, latching closure or screw closure, the dosage closure(s) preferably being openable and closable by a screwing operation.

The dosage taps are preferably configured such that the free-flowing media can be withdrawn by pressing a valve together or by pressing it downward or upward, or by tilting a wedge, cylinder or prism, especially a cuboid, or else a hemisphere.

It is also preferred when the at least one dosage closure or dosage tap is connected releasably to the film pouch(es). In this way, it is, for example, possible to reinsert the dosage closure or dosage tap after emptying of the film pouch and hence to reuse it. In addition, separate disposal of the dosage closure or dosage tap is possible in this way.

When the molded pulp vessel serves to package several different free-flowing media, it may be preferred that several differently filled film pouches and/or several differently filled chambers of one film pouch open in one dosage closure or dosage tap.

In this way, it is possible, for example, according to the flow rate through the feeds to the tap or closure predetermined on the basis of the geometry, to use several media in a predetermined ratio. For example, it is thus possible to use two media in a ratio of 1:2 or 1:3 or 2:3, etc., without any need for the consumer to weigh out or measure out the media individually.

A further advantage of this configuration is the possibility of mixing two or more media which enter into a chemical reaction on contact and form an active, especially short-lived, reagent, directly before application to a surface, and thus of providing the maximum amount of active reagent.

It is likewise advantageous to form visually appealing media mixtures when the individual media are of different color and/or consistency and the consumer can thus directly discern the multifunctionality of the totality of the media when the free-flowing media are poured out.

The opening of several receiving chambers of one film pouch and/or several film pouches into one dosage tap or dosage closure is, however, also advantageous in the case that all chambers or film vessels contain the same filling, the same medium. In this way, uniform withdrawal of the homogeneous filling is possible, and the consumer is not inconvenienced by, after emptying one chamber or one film pouch, having to open another. In the case of homogeneous filling, however, the package preferably has only one film pouch, especially one film pouch which has only one receiving chamber. Nevertheless, it may be preferred for reasons of stability or space filling to use several film pouches in this case too.

The inventive packages preferably comprise washing compositions, cleaning compositions, care compositions such as furniture polish or else laundry starch or fabric softener, disinfectants, pretreatment or aftertreatment compositions for the cleaning of solid surfaces or textiles, foods or cosmetics. The inventive package is preferably used as a storage unit, transport unit and/or dosage unit for free-flowing, especially liquid or gel-form and in particular liquid, washing compositions, cleaning compositions or care compositions. Accordingly, the present application provides for the use of the inventive package as a storage unit, transport unit and/or dosage unit for liquid washing compositions, cleaning compositions or care compositions.

The film pouches surrounded partly or completely by the molded pulp vessels preferably each independently enclose a volume of from 0.5 ml to 10 l, preferably from 5 ml to 5 l, more preferably from 50 ml to 2.5 l, more preferably from 100 ml to 2 l, and/or the film pouches enclose a total volume of from 1 ml to 10 l, preferably from 5 ml to 8 l, more preferably from 50 ml to 6 l and especially from 100 ml to 5 l.

It is possible, in the case in which the molded pulp vessel encloses a plurality of film pouches, that all film pouches have the same size, or else that the film pouches differ from one another in their volume slightly (up to 20% by volume) or significantly (over 20% by volume).

In a preferred embodiment, the inventive package does not have a handle. A corresponding configuration is notable for good stackability, low manufacturing costs and high mechanical stability of the molded pulp vessel.

In a further, likewise preferred embodiment, the molded pulp vessel, however, has a handle which consists of molded pulp material and is preferably integrated into the molded pulp vessel, or is formed by adhesive-bonding or rivet connection of a handle made of another material to the vessel body composed of molded pulp material.

Particularly the latter possibility enables use of a molded pulp vessel with few corners and/or curved regions. Such a vessel is more stable to mechanical stress and can be stacked better and thus transported and stored better. The subsequently mounted handle preferably consists of cardboard or plastic.

The film pouch(es) surrounded by the molded pulp vessel is/are preferably bonded to the molded pulp vessel inner wall at one or more points, preferably by means of adhesive bonds, latching connections, snap connections, plug connections, clamp connections or rivet connections.

It is particularly preferred in this context when the film pouch(es) is/are bonded to the molded pulp vessel, especially by adhesive bonds or clamp connections, at most 10, preferably at most 8, preferentially at most 6, more preferably at most 5, more preferably at most 4, with preference at most 3 and even more preferably at most 2 points and especially only at one point. The area of the bond between molded pulp vessel and film pouch(es) is preferably between 1 and 90 area %, preferably less than 75 area %, more preferably less than 50 area % and especially less than 25 area % of the inner area of the molded pulp vessel. In absolute terms, the bonded area is preferably not more 200 cm³ and not less than 0.25 cm³, preferably not more than 100 cm³, more preferably not more than 50 cm³, even more preferably not more than 25 cm³, with preference not more than 12 cm³, more preferably not more 6 cm³, even more preferably not more than 3 cm³ and especially between 0.5 and 1.5 cm³.

To form the adhesive bonds, physically setting adhesives (glues, pastes, solvent-based adhesives, dispersion adhesives, plastisol adhesives and hotmelt adhesives) and chemically setting adhesives (e.g. cyanoacrylate adhesives) are suitable. The physically setting adhesives may be solvent-free (hotmelt adhesives) or be solvent-containing. They set by changing their state of matter or through evaporation of the solvent before or during the adhesive bonding processes and generally have one component.

The chemically setting, one-component or multicomponent reaction adhesives may be based on all poly reactions: two-component systems composed of epoxy resins and acid anhydrides or polyamines react by polyaddition mechanisms, cyanoacrylates or methacrylates by polymerization mechanisms, and systems based on amino resins or phenol resins by polycondensation mechanisms.

Suitable adhesives for forming adhesive bonds between the film pouch(es) and the molded pulp vessels preferably include styrene-butadiene copolymers, polyamides, polyesters, polyvinyl chlorides, rubbers, polyurethane copolymers, vinyl acetate copolymers, vinyl chloride copolymers, vinylidene chloride copolymers, isoprene rubber, polyvinyl acetate, ethylene/vinyl acetate copolymers, polyvinylpyrrolidones, polyacrylates, polychloroprene, gluten, starch, dextrin, casein, cellulose ether, epoxy resins+acid anhydrides, epoxy resins+polyamines, polyisocyanates+polyols, cyanoacrylates, methacrylates, unsaturated polyesters+styrene, unsaturated polyesters+methacrylates, silicones+resins+moisture, phenol resins+polyvinyl formals or acrylonitrile/1,3-butadiene rubber/nitrile rubber, polyimides, polybenzimidazoles, urea resins, melamine-formaldehyde resins and/or phenol resins.

In a particularly preferred embodiment of the invention, the film pouch(es) surrounded by the molded pulp vessel is/are bonded to the molded pulp vessel inner wall at one or more points, preferably by means of adhesive bonds, latching connections, snap connections, plug connections, clamp connections or rivet connections.

This can achieve the effect that, on the one hand, the film pouch(es) is/are fixed in the molded pulp vessel and hence have a stable hold, but, on the other hand, the two elements can be separated from one another without destruction.

It may be preferred in specific cases not to bond the film pouch(es) to the molded pulp vessel.

This configuration, and also the configuration described above with a releasable bond between film pouch(es) and molded pulp vessel inner wall, can offer particular advantages. Firstly, separate disposal of the two elements of the package is thus facilitated. Secondly, in this way, it is enabled, for example, that one or more emptied film pouch(es) can be replaced by one or more full film pouch(es) in the molded pulp vessel, thus enabling reuse of the molded pulp vessel. It is possible either for individual film pouches alone to be exchangeable, or else it is possible for a multitude of film pouches, for example a composite formed from two or more film pouches, to be exchangeable with a single exchange operation. The exchange of the film pouches may be possible either together with the dosage closure or dosage tap, or without the latter, provided that the bond between film pouch(es) and dosage closure or dosage tap is releasable.

In a very particularly preferred embodiment of the invention, the inventive package is accordingly configured such that the film pouch(es) surrounded by the molded pulp vessel are either not bonded or are bonded releasably to the molded pulp vessel inner wall, and one or more film pouches can be removed from the molded pulp vessel without destruction and reinserted into the molded pulp vessel. It may also be preferred when the film pouch(es) open(s) in a combined dosage closure or dosage tap or a plurality of separate dosage closures or dosage taps which is/are removable from the molded pulp vessel and insertable into the molded pulp vessel together with the one or more film pouch(es).

According to the shape of the molded pulp vessel and of the film pouch(es), especially the degree to which the molded pulp vessel surrounds the film pouch(es), it may be required for destruction-free removability and insertability of the film pouches that the molded pulp vessel is openable and closable for withdrawal and/or for insertion of one or more film pouch(es). This may be required especially when the molded pulp vessel substantially or virtually completely surrounds the film pouch(es).

The present application further provides a process for producing an inventive package, wherein
a molded pulp material is produced, poured into a mold, dried and solidified to a molded pulp vessel,
at least one film pouch preferably equipped with a dosage closure or dosage tap is provided,
the film pouch(es) is/are introduced into the opened molded pulp vessel and preferably bonded to the vessel at least one point by means of adhesive bonds, latching connections, snap connections, plug connections, clamp connections or rivet connections, any bond present preferably being releasable,
the molded pulp vessel is optionally sealed.

Within this process, filling of the film pouch(es) can be undertaken at a wide variety of different times.

With preference, the film pouch(es) is/are filled and sealed before being introduced into the molded pulp vessel.

Alternatively, preference is given to filling and to sealing the film pouch(es) only after they are introduced into the molded pulp vessel. In this case, with preference, the molded pulp vessel is sealed only after the filling of the film pouch(es).

When the film pouch(es) is/are equipped with one or more dosage closure/dosage closures or dosage tap/dosage taps, with particular preference, the film pouch(es) is/are filled through the dosage closure/dosage closures or dosage tap/dosage taps. This is preferably not done until after the molded pulp vessel has been sealed.

To increase the stability of the molded pulp vessel, the molded pulp material, after being introduced into the mold and after a majority of liquid constituents have run off, is preferably pressed. This achieves a denser order of the individual fibers and hence a higher mechanical stability. By virtue of the pressing, it is additionally possible to produce molded pulp vessels with sharper shapes, i.e. sharp corners and edges and simultaneously thick surfaces.

Generally, the molded pulp vessel may have any conceivable shape, for example may be cylindrical or prismatic, especially in the shape of a cuboid, specifically of a cube, or may be of a shape resembling or corresponding to a frustocone or frustopyramid. It is preferred that the molded pulp vessel has the shape of a cuboid and thus, for example, resembles the shape of a washing powder box in the field of washing compositions, cleaning compositions or care compositions.

Alternatively, the molded pulp vessel preferably has the shape of a customary plastic container for liquid media, such that the consumer does not at first glance discern that the package is a molded pulp vessel. Such a vessel has an integrated handle, a round, oval or rectangular footprint and narrows in the upward direction. It is also conceivable that such a vessel does not narrow in the upward direction and thus has the basic shape of a cuboid in which a handle is integrated.

The molded pulp vessel preferably serves simultaneously for shaping/configuration and stabilization of the overall package.

For the purpose of producing the inventive package, it is also preferred to immerse one or more filled film pouches into a molded pulp material and thus to utilize the filled film pouch(es) as a positive mold instead of as a negative mold. Thereafter, the molded pulp material is dried and solidified. The depth to which the film pouch(es) has/have been immersed into the molded pulp material determines here to what extent the film pouch(es) is/are surrounded by the hardened molded pulp material which then forms the molded pulp vessel.

The present application further provides a process for producing an inventive package, characterized in that
at least one film pouch preferably equipped with a dosage closure or dosage tap is provided,
the film pouch(es) is/are filled and sealed,
the film pouch(es) is/are contacted with a molded pulp material such that the film pouch(es) is/are partly or completely covered with the molded pulp material, and
the molded pulp material is dried and solidified to a molded pulp vessel.

The free-flowing media present in the film pouch(es) are preferably mobile to highly viscous. In the context of the present invention, “liquid” denotes compositions which are free-flowing at room temperature and can run out of vessels under the action of gravity. Particular preference is given to media which have a viscosity (Brookfield viscometer LVT-II at 20 rpm and 20° C., spindle 3) of from 500 to 50 000 mPas, preferably from 1000 to 10 000 mPas, more preferably from 1200 to 5000 mPas and especially from 1300 to 3000 mPas.

Useful fillings of the inventive package include all free-flowing media, but especially washing compositions, cleaning compositions or care compositions.

The most important constituents of these preferred fillings will be detailed hereinafter:

To establish a possibly desired higher viscosity, the free-flowing media may comprise viscosity regulators or thickeners. In this context, it is possible to use all known thickeners, especially those based on natural or synthetic polymers.

Polymers originating in nature which find use as thickeners are, for example, agar-agar, carrageenan, tragacanth, gum arabic, alginates, pectins, polyoses, guar flour, carob seed flour, starch, dextrins, gelatins and casein.

Modified natural substances originate primarily from the group of modified starches and celluloses, examples including carboxymethylcellulose and other cellulose ethers such as hydroxyethylcellulose and hydroxypropylcellulose, and seed flour ethers.

A large group of thickeners which is used widely in very diverse fields of application is that of the fully synthetic polymers, such as polyacrylic and polymethacrylic compounds, vinyl polymers, polycarboxylic acids, polyethers, polyimines, polyamides and polyurethanes.

Thickeners from said substance classes are commercially widely available and are obtainable, for example, under the trade names Acusol®-820 (methacrylic acid (stearyl alcohol-20-EO) ester-acrylic acid copolymer, 30% strength in water, Rohm & Haas), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-mannose, D-glucuronic acid, Schöner GmbH), Deuteron®-XN (nonionogenic polysaccharide, Schoner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A polymeric thickener to be used with preference is xanthan, a microbial anionic heteropolysaccharide which is produced by Xanthomonas campestris and some other species under aerobic conditions and has a molar mass of from 2 to 15 million daltons. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

Thickeners which are likewise to be used with preference in the context of the present invention are polyurethanes or modified polyacrylates which, based on the overall composition, can be used, for example, in amounts of from 0.1 to 5% by weight, based on the overall composition.

Polyurethanes (PUs) are prepared by polyaddition from dihydric and higher polyhydric alcohols and isocyanates and can be described by the following general formula:

[—O—R¹—O—C(O)—NH—R²—NH—C(O)—]ₙ

in which R¹ is a low molecular weight or polymeric diol radical, R² is an aliphatic or aromatic group and n is a natural number. R¹ is preferably a linear or branched C₂₋₁₂-alk(en)yl group, but may also be a radical of a higher polyhydric alcohol, which forms crosslinked polyurethanes which differ from the formula specified in that further —O—CO—NH— groups are bonded to the R¹ radical.

Industrially important PUs are prepared from polyester diols and/or polyether diols and, for example, from tolylene 2,4- or 2,6-diisocyanate (TDI, R²=C₆H₃—CH₃), methylene 4,4′-di(phenyl isocyanate) (MDI, R²=C₆H₄—CH₂—C₆H₄) or hexamethylene diisocyanate [HMDI, R⁴=(CH₂)₆].

Commercial thickeners based on polyurethane are obtainable, for example, under the names Acrysol®PM 12 V (mixture of 3-5% modified starch and 14-16% PU resin in water, Rohm & Haas), Borchigel® L75-N (nonionogenic PU dispersion, 50% in water, Borchers), Coatex® BR-100-P (PU dispersion, 50% in water/butylglycol, Dimed), Nopco® DSX-1514 (PU dispersion, 40% in water/butyltriglycol, Henkel-Nopco), Verdicker QR 1001 (20% PU emulsion in water/diglycol ether, Rohm & Haas) and Rilanit® VPW-3116 (PU dispersion, 43% in water, Henkel).

Modified polyacrylates derive, for example, from acrylic acid or methacrylic acid and can be described by the following general formula:

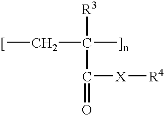

in which R³ is H or a branched or unbranched C₁₋₄-alk(en)yl radical, X is N—R⁵ or O, R⁴ is an optionally alkoxylated, branched or unbranched, possibly substituted C₈₋₂₂-alk(en)yl radical, R⁵ is H or R⁴, and n is a natural number. In general, such modified polyacrylates are esters or amides of acrylic acid or of an α-substituted acrylic acid. Among these polymers, preference is given to those in which R³ is H or a methyl group. In the polyacrylamides (X=N—R⁵), both mono-N-substituted (R⁵=H) and di-N-substituted (R⁵=R⁴) amide structures are possible, and the two hydrocarbon radicals which are bonded to the nitrogen atom may each independently be selected from optionally alkoxylated, branched or unbranched C₈₋₂₂-alk(en)yl radicals. Among the polyacrylic esters (X=O), preference is given to those in which the alcohol has been obtained from natural or synthetic fats or oils and is additionally alkoxylated, preferably ethoxylated. Preferred degrees of alkoxylation are between 2 and 30, degrees of alkoxylation between 10 and 15 being particularly preferred.

Since the usable polymers are technical compounds, the designation of the radicals bonded to X constitutes a statistical average which can vary with regard to chain length and degree of alkoxylation in the individual case. The formula specified merely specifies formulae for idealized homopolymers. However, it is also possible in the context of the present invention to use copolymers in which the proportion of monomer units which satisfy the above formula is at least 30% by weight. For example, it is also possible to use copolymers of modified polyacrylates and acrylic acid or salts thereof which still have acidic hydrogen atoms or basic —COO— groups.

Modified polyacrylates to be used with preference as thickeners are polyacrylate-polymethacrylate copolymers which satisfy the following formula

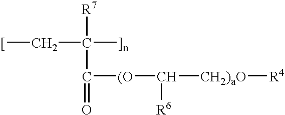

in which R⁴ is a preferably unbranched, saturated or unsaturated C₈₋₂₂-alk(en)yl radical, R⁶ and R⁷ are each independently H or CH₃, the degree of polymerization n is a natural number and the degree of alkoxylation a is a natural number between 2 and 30, preferably between 10 and 20. R⁴ is preferably a fatty alcohol radical which has been obtained from natural or synthetic sources, the fatty alcohol in turn being preferably ethoxylated (R⁶=H).

Corresponding products are commercially available, for example, under the name Acusol® 820 (Rohm & Haas) in the form of 30% by weight dispersions in water. In the commercial product mentioned, R⁴ is a stearyl radical, R⁶ is a hydrogen atom, R⁷ is H or CH₃, and the degree of ethoxylation a is 20.

Particularly preferred thickeners are hydroxyethylcellulose and/or hydroxypropylcellulose and/or thickeners from the group of the polysaccharides, preferably xanthans, of the polyurethanes or of the modified polyacrylates, with particular preference for thickeners of the formula

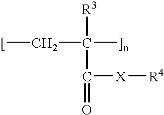

in which R³ is H or a branched or unbranched C₁₋₄-alk(en)yl radical, X is N—R⁵ or O, R⁴ is an optionally alkoxylated, branched or unbranched, possibly substituted C₈₋₂₂-alk(en)yl radical, R⁵ is H or R⁴, and n is a natural number.

The liquid or gel-formed media preferably comprise solvents/solvent mixtures which as well as or instead of water, may comprise further nonaqueous solvents. These nonaqueous solvents stem, for example, from the group of the monoalcohols, diols, triols or polyols, or of the ethers, esters and/or amides. Particular preference is given to nonaqueous solvents which are water-soluble, “water-soluble” solvents in the context of the present application being solvents which are fully miscible, i.e. without a miscibility gap, with water at room temperature.

Nonaqueous solvents which can be used in the free-flowing media stem preferably from the group of mono- or polyhydric alcohols, alkanolamines or glycol ethers. The solvents are preferably selected from ethanol, n- or i-propanol, n- or sec- or tert-butanol, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy-, ethoxy- or butoxytriglycol, 1-butoxyethoxy-2-propanol, 3-methyl-3-methoxybutanol and propylene glycol-t-butyl ether.

Free-flowing media which are particularly preferred in the context of the present invention comprise nonaqueous solvent(s) in amounts of from 0.1 to 70% by weight, preferably from 0.5 to 60% by weight, more preferably from 1 to 50% by weight, even more preferably from 2 to 40% by weight and especially from 2.5 to 30% by weight, based in each case on the overall composition, preferred nonaqueous solvent(s) being selected from the group consisting of the room temperature liquid nonionic surfactants, of the polyethylene glycols and polypropylene glycols, glycerol, glyceryl carbonate, triacetin, ethylene glycol, propylene glycol, propylene carbonate, hexylene glycol, ethanol, and also n-propanol and/or isopropanol.

The room temperature liquid nonionic surfactants are described in detail below as washing- or cleaning-active substances.

Polyethylene glycols usable in accordance with the invention (abbreviation: PEG) are polymers of ethylene glycol which satisfy the general formula

H—(O—CH₂—CH₂)ₙ—OH

where n may assume values between 1 (ethylene glycol, see below) and approx. 16. For polyethylene glycols, there exist various nomenclatures which can lead to confusion. Commonly used in industry is the statement of the mean relative molar mass after “PEG”, such that “PEG 200” characterizes a polyethylene glycol having a relative molar mass of approx. 190 to approx. 210. According to this nomenclature, the industrially common polyethylene glycols PEG 200, PEG 300, PEG 400 and PEG 600 can be used in the context of the present invention.

For cosmetic ingredients, a different nomenclature is used, in which the abbreviation PEG is followed by a hyphen and the hyphen is followed directly by a number which corresponds to the number n in the abovementioned formula. According to this nomenclature (so-called INCI nomenclature, CTFA International Cosmetic Ingredient Dictionary and Handbook, 5th Edition, The Cosmetic, Toiletry and Fragrance Association, Washington, 1997), it is possible to use, for example, PEG-4, PEG-6, PEG-8, PEG-9, PEG-10, PEG-12, PEG-14 and PEG-16.

Polyethylene glycols are commercially available, for example, under the trade names Carbowax® PEG 200 (Union Carbide), Emkapol® 200 (ICI Americas), Lipoxol® 200 MED (HÜLS America), Polyglycol® E-200 (Dow Chemical), Alkapol® PEG 300 (Rhone-Poulenc), Lutrol® E300 (BASF), and the corresponding trade names with higher numbers.

Polypropylene glycols which are likewise usable (abbreviation: PPG) are polymers of propylene glycol which satisfy the general formula

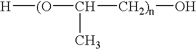

where n may assume values between 1 (propylene glycol, see below) and approx. 12. Of industrial significance here are especially di-, tri- and tetrapropylene glycol, i.e. the representatives where n=2, 3 and 4 in the above formula.

Glycerol is a colorless, clear, viscous, odorless sweet-tasting hygroscopic liquid of density 1.261, which solidifies at 18.2° C. Glycerol was originally only a by-product of fat hydrolysis, but is now synthesized industrially in large amounts. Most industrial processes proceed from propene, which is processed via the intermediates of allyl chloride and epichlorohydrin to glycerol. A further industrial process is the hydroxylation of allyl alcohol with hydrogen peroxide over a WO₃ catalyst via the stage of the glycide.

Glycerol carbonate is obtainable by transesterifying ethylene carbonate or dimethyl carbonate with glycerol, the by-product obtained being ethylene glycol or methanol. A further synthesis route proceeds from glycidol (2,3-epoxy-1-propanol), which is reacted with CO₂ under pressure in the presence of catalysts to give glyceryl carbonate. Glyceryl carbonate is a clear mobile liquid having a density of 1.398 gcm⁻³, which boils at 125-130° C. (0.15 mbar).

Ethylene glycol (1,2-ethanediol, “glycol”) is a colorless, viscous, sweet-tasting, highly hygroscopic liquid which is miscible with water, alcohols and acetone and has a density of 1.113. The solidification point of ethylene glycol is −11.5° C.; the liquid boils at 198° C. Ethylene glycol is obtained industrially from ethylene oxide by heating with water under pressure. Promising preparation processes can also be built on the acetoxylation of ethylene and subsequent hydrolysis, or on synthesis gas reactions.

There exist two isomers of propylene glycol, 1,3-propanediol and 1,2-propanediol. 1,3-Propanediol (trimethylene glycol) is a neutral, colorless and odorless, sweet-tasting liquid of density 1.0597, which solidifies at −32° C. and boils at 214° C. The preparation of 1,3-propanediol succeeds from acrolein and water with subsequent catalytic hydrogenation.

Industrially far more significant is 1,2-propanediol (propylene glycol), which is an oily, colorless, almost odorless liquid of density 1.0381, which solidifies at −60° C. and boils at 188° C. 1,2-Propanediol is prepared from propylene oxide by addition of water.

Propylene carbonate is a water-clear mobile liquid with a density of 1.21 gcm⁻³; the melting point is −49° C., the boiling point 242° C. Propylene carbonate is also obtainable on the industrial scale by reaction of propylene oxide and CO₂ at 200° C. and 80 bar.

In the free-flowing medium, which preferably further comprises one or more of the aforementioned or other nonaqueous solvents and/or water, preferably one or more active substances from the group of the bleaches, bleach activators, bleach catalysts, polymers, builders, surfactants, enzymes, electrolytes, pH modifiers, fragrances, perfume carriers, dyes, hydrotropes, foam inhibitors, antiredeposition agents, optical brighteners, graying inhibitors, shrinkproofing agents, creaseproofing agents, dye transfer inhibitors, active antimicrobial ingredients, germicides, fungicides, antioxidants, corrosion inhibitors, antistats, repellency and impregnation agents, antiswell and antislip agents, nonaqueous solvents, fabric softeners, protein hydrolyzates, and UV absorbers, is/are dissolved or suspended.

These preferred ingredients will be described in detail hereinafter.

The builders include especially the zeolites, silicates, carbonates, organic cobuilders and, where there are no ecological objections to their use, also the phosphates.

With preference, crystalline sheet-type silicates of the general formula NaMSiₓO₂ₓ₊₁.yH₂O are used, where M is sodium or hydrogen, x is a number from 1.9 to 22, preferably from 1.9 to 4, particularly preferred values of x being 2, 3 or 4, and y is a number from 0 to 33, preferably from 0 to 20. The crystalline sheet-type silicates of the formula NaMSiₓO₂ₓ₊₁.yH₂O are sold, for example, by Clariant GmbH (Germany) under the trade name Na-SKS. Examples of these silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite).

Particularly suitable for the purposes of the present invention are crystalline sheet silicates of the formula NaMSiₓO₂ₓ₊₁.yH₂O in which x is 2. Especially preferred are both β- and δ-sodium disilicates Na₂Si₂O₅.yH₂O, and also in particular Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but especially Na-SKS-6 (δ-Na₂Si₂O₅).

Washing or cleaning compositions preferably comprise a proportion by weight of the crystalline sheet-type silicate of the formula NaMSiₓO₂ₓ₊₁.yH₂O of from 0.1 to 20% by weight, of from 0.2 to 15% by weight and in particular from 0.4 to 10% by weight, based in each case on the total weight of these compositions.

It is also possible to use amorphous sodium silicates having an Na₂O:SiO₂ modulus of from 1:2 to 1:3.3, preferably from 1:2 to 1:2.8 and in particular from 1:2 to 1:2.6, which preferably have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” is understood to mean that the silicates do not afford any sharp X-ray reflections in X-ray diffraction experiments, as are typical of crystalline substances, but rather yield at best one or more maxima of the scattered X-radiation, which have a width of several degree units of the diffraction angle.

Alternatively or in combination with the aforementioned amorphous sodium silicates, X-ray-amorphous silicates are used, whose silicate particles in electron diffraction experiments yield vague or even sharp diffraction maxima. This is to be interpreted such that the products have microcrystalline regions with a size of from 10 to several hundred nm, preference being given to values up to a maximum of 50 nm and in particular up to a maximum of 20 nm. Such X-ray-amorphous silicates likewise have retarded dissolution compared with conventional waterglasses. Special preference is given to compacted amorphous silicates, compounded amorphous silicates and overdried X-ray-amorphous silicates.

In the context of the present invention, it is preferred that this/these silicate(s), preferably alkali metal silicates, more preferably crystalline or amorphous alkali metal disilicates, is/are present in washing or cleaning compositions in amounts of from 3 to 60% by weight, preferably from 8 to 50% by weight and in particular from 20 to 40% by weight, based in each case on the weight of the washing or cleaning composition.

It is of course also possible to use the commonly known phosphates as builder substances, as long as such a use is not to be avoided for ecological reasons. Among the multitude of commercially available phosphates, the alkali metal phosphates, with particular preference for pentasodium triphosphate or pentapotassium triphosphate (sodium tripolyphosphate or potassium tripolyphosphate), have the greatest significance in the washing and cleaning products industry.

Alkali metal phosphates is the collective term for the alkali metal (especially sodium and potassium) salts of the various phosphoric acids, for which a distinction may be drawn between metaphosphoric acids (HPO₃)ₙ and orthophosphoric acid H₃PO₄, in addition to higher molecular weight representatives. The phosphates combine a number of advantages: they act as alkali carriers, prevent limescale deposits on machine components and lime encrustations in fabrics, and additionally contribute to the cleaning performance.

Industrially particularly important phosphates are pentasodium triphosphate, Na₅P₃O₁₀ (sodium tripolyphosphate), and the corresponding potassium salt, pentapotassium triphosphate, K₅P₃O₁₀ (potassium tripolyphosphate). Preference is also given in accordance with the invention to the sodium potassium tripolyphosphates.

When phosphates are used as washing- or cleaning-active substances in washing or cleaning compositions in the context of the present application, preferred compositions comprise these phosphate(s), preferably alkali metal phosphate(s), more preferably pentasodium triphosphate or pentapotassium triphosphate (sodium tripolyphosphate or potassium tripolyphosphate), in amounts of from 5 to 80% by weight, preferably from 15 to 75% by weight and in particular from 20 to 70% by weight, based in each case on the weight of the washing or cleaning composition.

Further builders are the alkali carriers. Alkali carriers include, for example, alkali metal hydroxides, alkali metal carbonates, alkali metal hydrogencarbonates, alkali metal sesquicarbonates, the aforementioned alkali metal silicates, alkali metal metasilicates and mixtures of the aforementioned substances, preference being given in the context of this invention to using the alkali metal carbonates, especially sodium carbonate, sodium hydrogencarbonate or sodium sesquicarbonate. Particular preference is given to a builder system comprising a mixture of tripolyphosphate and sodium carbonate. Owing to their low chemical compatibility with the remaining ingredients of washing or cleaning compositions in comparison with other builder substances, the alkali metal hydroxides are preferably used only in small amounts, preferably in amounts below 10% by weight, preferentially below 6% by weight, more preferably below 4% by weight and in particular below 2% by weight, based in each case on the total weight of the washing or cleaning composition. Particular preference is given to compositions which, based on their total weight, contain less than 0.5% by weight of and in particular no alkali metal hydroxides.

Particular preference is given to the use of carbonate(s) and/or hydrogencarbonate(s), preferably alkali metal carbonate(s), more preferably sodium carbonate, in amounts of from 2 to 50% by weight, preferably from 5 to 40% by weight and in particular from 7.5 to 30% by weight, based in each case on the weight of the washing or cleaning composition. Particular preference is given to compositions which, based on the weight of the washing or cleaning composition, contain less than 20% by weight, preferably less than 17% by weight, preferentially less than 13% by weight and in particular less than 9% by weight of carbonate(s) and/or hydrogencarbonate(s), preferably alkali metal carbonate(s), more preferably sodium carbonate.

Organic cobuilders include in particular polycarboxylates/polycarboxylic acids, polymeric polycarboxylates, aspartic acid, polyacetals, dextrins, further organic cobuilders (see below) and phosphonates. These substance classes are described below.

Organic builder substances which can be used are, for example, the polycarboxylic acids usable in the form of the free acid and/or of their sodium salts, polycarboxylic acids referring to those carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. In addition to their builder action, the free acids typically also have the property of an acidifying component and thus also serve to set a lower and milder pH of washing or cleaning compositions. In this connection, particular mention should be made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70 000 g/mol.

In the context of this document, the molar masses specified for polymeric polycarboxylates are weight-average molar masses M_{W} of the particular acid form, which have always been determined by means of gel-permeation chromatography (GPC) using a UV detector. The measurement was against an external polyacrylic acid standard which, owing to its structural similarity to the polymers under investigation, provides realistic molecular weight values. These figures deviate considerably from the molecular weight data when polystyrenesulfonic acids are used as the standard. The molar masses measured against polystyrenesulfonic acids are generally significantly higher than the molar masses specified in this document.

Suitable polymers are in particular polyacrylates which preferably have a molecular mass of from 2000 to 20 000 g/mol. Owing to their superior solubility, preference within this group may be given in turn to the short-chain polyacrylates which have molar masses of from 2000 to 10 000 g/mol and more preferably from 3000 to 5000 g/mol.

Also suitable are copolymeric polycarboxylates, especially those of acrylic acid with methacrylic acid and of acrylic acid or methacrylic acid with maleic acid. Copolymers which have been found to be particularly suitable are those of acrylic acid with maleic acid which contain from 50 to 90% by weight of acrylic acid and from 50 to 10% by weight of maleic acid. Their relative molecular mass, based on free acids, is generally from 2000 to 70 000 g/mol, preferably from 20 000 to 50 000 g/mol and in particular from 30 000 to 40 000 g/mol.

The (co)polymeric polycarboxylates can either be used in the form of powders or in the form of aqueous solutions. The (co)polymeric polycarboxylate content of the washing or cleaning compositions is preferably from 0.5 to 20% by weight, in particular from 3 to 10% by weight.

To improve the water solubility, the polymers may also contain allylsulfonic acids, for example allyloxybenzenesulfonic acid and methallylsulfonic acid, as monomers.

Also especially preferred are biodegradable polymers composed of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallylsulfonic acid, and sugar derivatives.

Further preferred copolymers are those which preferably have, as monomers, acrolein and acrylic acid/acrylic acid salts or acrolein and vinyl acetate.

Further preferred builder substances which should likewise be mentioned are polymeric aminodicarboxylic acids, salts thereof or precursor substances thereof. Particular preference is given to polyaspartic acids or salts thereof.

Further suitable builder substances are polyacetals which can be obtained by reacting dialdehydes with polyolcarboxylic acids which have from 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500 000 g/mol. Preference is given to a polysaccharide having a dextrose equivalent (DE) in the range from 0.5 to 40, in particular from 2 to 30, where DE is a common measure of the reducing action of a polysaccharide compared to dextrose, which has a DE of 100. It is also possible to use maltodextrins with a DE between 3 and 20 and dry glucose syrups with a DE between 20 and 37, and also yellow dextrins and white dextrins having relatively high molar masses in the range from 2000 to 30 000 g/mol.

The oxidized derivatives of such dextrins are their reaction products with oxidizing agents which are capable of oxidizing at least one alcohol function of the saccharide ring to the carboxylic acid function.

Oxydisuccinates and other derivatives of disuccinates, preferably ethylenediaminedisuccinate, are also further suitable cobuilders. In this case, ethylenediamine-N,N′-disuccinate (EDDS) is preferably used in the form of its sodium or magnesium salts. Furthermore, in this connection, preference is also given to glyceryl disuccinates and glyceryl trisuccinates. Suitable use amounts in zeolite-containing and/or silicate-containing formulations are from 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and a maximum of two acid groups.

In addition, it is possible to use all compounds which are capable of forming complexes with alkaline earth metal ions as builders.

The group of the surfactants includes the nonionic, the anionic, the cationic and the amphoteric surfactants.

The nonionic surfactants used may be all nonionic surfactants known to those skilled in the art. Suitable nonionic surfactants are, for example, alkyl glycosides of the general formula RO(G)X in which R is a primary straight-chain or methyl-branched, in particular 2-methyl-branched, aliphatic radical having from 8 to 22, preferably from 12 to 18, carbon atoms and G is the symbol which is a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain.

Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula

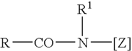

in which R is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula

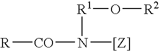

in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

The preferred surfactants used are low-foaming nonionic surfactants. With particular preference, washing or cleaning compositions, especially cleaning compositions for machine dishwashing, comprise nonionic surfactants from the group of the alkoxylated alcohols. The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

With particular preference, therefore, ethoxylated nonionic surfactants which have been obtained from C₆₋₂₀-monohydroxyalkanols or C₆₋₂₀-alkylphenols or C₁₆₋₂₀-fatty alcohols and more than 12 mol, preferably more than 15 mol and especially more than 20 mol of ethylene oxide per mole of alcohol are used. A particularly preferred nonionic surfactant is obtained from a straight-chain fatty alcohol having from 16 to 20 carbon atoms (C₁₆₋₂₀-alcohol), preferably a C₁₋₈-alcohol, and at least 12 mol, preferably at least 15 mol and in particular at least 20 mol, of ethylene oxide. Of these, the “narrow range ethoxylates” are particularly preferred.

With particular preference, moreover, surfactants which contain one or more tallow fat alcohols with 20 to 30 EO in combination with a silicone defoamer are used.

Special preference is given to nonionic surfactants which have a melting point above room temperature, particular preference being given to nonionic surfactants having a melting point above 20° C., preferably above 25° C., more preferably between 25 and 60° C. and in particular between 26.6 and 43.3° C.

Suitable nonionic surfactants which have melting or softening points in the temperature range specified are, for example, low-foaming nonionic surfactants which may be solid or highly viscous at room temperature. When nonionic surfactants which have a high viscosity at room temperature are used, they preferably have a viscosity above 20 Pa·s, preferably above 35 Pa·s and in particular above 40 Pa·s. Nonionic surfactants which have a waxlike consistency at room temperature are also preferred, depending on their end use.

Nonionic surfactants from the group of the alkoxylated alcohols, more preferably from the group of the mixed alkoxylated alcohols and in particular from the group of the EO-AO-EO nonionic surfactants, are likewise used with particular preference.

The room temperature solid nonionic surfactant preferably additionally has propylene oxide units in the molecule. Preferably, such PO units make up up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants. Preferred compositions are characterized in that they comprise ethoxylated and propoxylated nonionic surfactants in which the propylene oxide units in the molecule make up up to 25% by weight, preferably up to 20% by weight and in particular up to 15% by weight, of the total molar mass of the nonionic surfactant.

Surfactants for use with preference stem from the groups of alkoxylated nonionic surfactants, in particular the ethoxylated primary alcohols and mixtures of these surfactants with structurally complex surfactants, such as polyoxypropylene/polyoxyethylene/polyoxypropylene ((PO/EO/PO) surfactants). Such (PO/EO/PO) nonionic surfactants are additionally notable for good foam control.

Further nonionic surfactants with melting points above room temperature for use with particular preference contain from 40 to 70% of a polyoxypropylene/polyoxyethylene/polyoxy-propylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Particularly preferred nonionic surfactants in the context of the present invention have been found to be low-foaming nonionic surfactants which have alternating ethylene oxide and alkylene oxide units. Among these, preference is given in turn to surfactants having EO-AO-EO-AO blocks, and in each case from one to ten EO and/or AO groups are bonded to one another before a block of the other groups in each case follows. Preference is given here to nonionic surfactants of the general formula

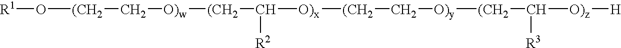

in which R¹ is a straight-chain or branched, saturated or mono- or polyunsaturated C₆₋₂₄-alkyl or -alkenyl radical; each R² or R³ group is independently selected from —CH₃, —CH₂CH₃, —CH₂CH₂—CH₃, CH(CH₃)₂ and the indices w, x, y, z are each independently integers from 1 to 6.

The preferred nonionic surfactants of the above formula can be prepared by known methods from the corresponding alcohols R¹—OH and ethylene oxide or alkylene oxide. The R¹ radical in the above formula may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in the compositions, preference is given to nonionic surfactants in which R¹ in the above formula is an alkyl radical having from 6 to 24, preferably from 8 to 20, more preferably from 9 to 15 and in particular from 9 to 11 carbon atoms.

The alkylene oxide unit which is present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and CH(CH₃)₂ are also suitable. Preference is given to using nonionic surfactants of the above formula in which R² and R³ are each a —CH₃ radical, w and x are each independently 3 or 4, and y and z are each independently 1 or 2.

In summary, preference is given in particular to nonionic surfactants which have a C₉₋₁₅-alkyl radical having from 1 to 4 ethylene oxide units, followed by from 1 to 4 propylene oxide units, followed by from 1 to 4 ethylene oxide units, followed by from 1 to 4 propylene oxide units. In aqueous solution, these surfactants have the required low viscosity and can be used with particular preference in accordance with the invention.

Preference is given in accordance with the invention to surfactants of the general formula

R¹—CH(OH)CH₂O-(AO)_{w}-(A′O)-(A″O)_{y}-(A′″O)_{z}—R²

in which R¹ and R² are each independently a straight-chain or branched, saturated or mono- or polyunsaturated C₂₋₄₀-alkyl or -alkenyl radical; A, A′, A″ and A′″ are each independently a radical selected from the group of —CH₂CH₂, —CH₂CH₂—CH₂, —CH₂CH(CH₃), —CH₂—CH₂—CH₂—CH₂, —CH₂—CH(CH₃)—CH₂, —CH₂—CH(CH₂—CH₃); and w, x, y, z are each values from 0.5 to 90, where x, y and/or z may also be 0.

Preference is given especially to those end group-capped poly(oxyalkylated) nonionic surfactants which, according to the formula

R¹O[CH₂CH₂O]ₓCH₂CH(OH)R²,

have not only an R¹ radical which represents linear or branched, saturated or unsaturated, aliphatic or aromatic hydrocarbon radicals having from 2 to 30 carbon atoms, preferably having from 4 to 22 carbon atoms, but also a linear or branched, saturated or unsaturated, aliphatic or aromatic hydrocarbon radical R² having from 1 to 30 carbon atoms, where x is from 1 to 90, preferably from 40 to 80 and especially from 40 to 60.

Particular preference is given to surfactants of the formula

R¹O[CH₂CH(CH₃)O]ₓ[CH₂CH₂O]_{y}CH₂CH(OH)R²

in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is from 0.5 to 1.5, and y is a value of at least 15.

Particular preference is further given to those end group-capped poly(oxyalkylated) nonionic surfactants of the formula

R¹O[CH₂CH₂O]ₓ[CH₂CH(CH₃)O]_{y}CH₂CH(OH)R²

in which R¹ and R² are each independently a linear or branched, saturated or mono- or polyunsaturated hydrocarbon radical having from 2 to 26 carbon atoms, R³ is independently selected from —CH₃, —CH₂CH₃, —CH₂CH₂—CH₃, CH(CH₃)₂, but is preferably —CH₃, and x and y are each independently from 1 to 32, very particular preference being given to nonionic surfactants where R³=CH₃ and with values for x of from 15 to 32 and y of 0.5 and 1.5.

Further nonionic surfactants which can be used with preference are the end group-capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is from 1 to 30, k and j are from 1 to 12, preferably from 1 to 5. When the value x≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x≧2. This allows the alkylene oxide unit in the square brackets to be varied. When x is, for example, 3, the R³ radical may be selected so as to form ethylene oxide (R³=H) or propylene oxide (R³=CH₃) units which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and it is entirely possible for it to be larger, the scope of variation increasing with increasing x values and embracing, for example, a large number of (EO) groups combined with a small number of (PO) groups, or vice versa.

Particularly preferred end group-capped poly(oxyalkylated) alcohols of the above formula have values of k=1 and j=1, such that the above formula is simplified to

R¹O[CH₂CH(R³)O]ₓCH₂CH(OH)CH₂OR².

In the latter formula, R¹, R² and R³ are each as defined above and x is a number from 1 to 30, preferably from 1 to 20 and in particular from 6 to 18. Particular preference is given to surfactants in which the R¹ and R² radicals have from 9 to 14 carbon atoms, R³ is H and x assumes values of from 6 to 15.

The specified carbon chain lengths and degrees of ethoxylation or degrees of alkoxylation of the aforementioned nonionic surfactants constitute statistical averages which may be a whole number or a fraction for a specific product. As a consequence of the preparation process, commercial products of the formulae specified do not usually consist of one individual representative, but rather of mixtures, as a result of which average values and consequently fractions can arise both for the carbon chain lengths and for the degrees of ethoxylation or degrees of alkoxylation.

It will be appreciated that the aforementioned nonionic surfactants may be used not only as individual substances but also as surfactant mixtures of two, three, four or more surfactants. Surfactant mixtures refer not only to mixtures of nonionic surfactants which, in their entirety, fall under one of the abovementioned general formulae, but also those mixtures which comprise two, three, four or more nonionic surfactants which can be described by different general formulae among those above.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of α-sulfo fatty acids (ester sulfonates), for example the α-sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which can be obtained as commercial products from the Shell Oil Company under the name DAN®, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO. Owing to their high tendency to foam, they are used in cleaning compositions only in relatively small amounts, for example amounts of from 1 to 5% by weight.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈-fatty alcohol radicals or mixtures thereof. Especially preferred sulfosuccinates contain a fatty alcohol radical which is derived from ethoxylated fatty alcohols which, considered alone, constitute nonionic surfactants. In this context, particular preference is again given to sulfosuccinates whose fatty alcohol radicals are derived from ethoxylated fatty alcohols with a narrowed homolog distribution. It is also equally possible to use alk(en)ylsuccinic acid having preferably from 8 to 18 carbon atoms in the alk(en)yl chain or salts thereof.

Useful further anionic surfactants are in particular soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

Instead of the surfactants mentioned or in conjunction with them, it is also possible to use cationic and/or amphoteric surfactants.

The cationic active substances used may, for example, be cationic compounds of the following formulae:

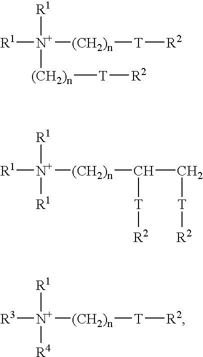

in which each R¹ group is independently selected from C₁₋₆-alkyl, -alkenyl and -hydroxyalkyl groups; each R² group is independently selected from C₈₋₂₈-alkyl and -alkenyl groups; R³=R¹ or (CH₂)ₙ-T-R²; R⁴=R¹ or R² or (CH₂)ₙ-T-R²; T=—CH₂—, —O—CO— or —CO—O— and n is an integer from 0 to 5.

In machine dishwasher detergents, the content of cationic and/or amphoteric surfactants is preferably less than 6% by weight, preferentially less than 4% by weight, even more preferably less than 2% by weight and in particular less than 1% by weight. Particular preference is given to machine dishwasher detergents which do not contain any cationic or amphoteric surfactants.

The group of polymers includes in particular the washing- or cleaning-active polymers, for example the rinse aid polymers and/or polymers active as softeners. Generally, not only nonionic polymers but also cationic, anionic and amphoteric polymers can be used in washing or cleaning compositions.

“Cationic polymers” in the context of the present invention are polymers which bear a positive charge in the polymer molecule. This can be realized, for example, by (alkyl)ammonium moieties present in the polymer chain or other positively charged groups. Particularly preferred cationic polymers stem from the groups of the quaternized cellulose derivatives, the polysiloxanes with quaternary groups, the cationic guar derivatives, the polymer dimethyldiallylammonium salts and copolymers thereof with esters and amides of acrylic acid and methacrylic acid, the copolymers of vinylpyrrolidone with quaternized derivatives of dialkylaminoacrylate and -methacrylate, the vinylpyrrolidone-methoimidazolinium chloride copolymers, the quaternized polyvinyl alcohols, or the polymers specified under the INCI designations Polyquaternium 2, Polyquaternium 17, Polyquaternium 18 and Polyquaternium 27.

“Amphoteric polymers” in the context of the present invention have, in addition to a positively charged group in the polymer chain, also negatively charged groups or monomer units. These groups may, for example, be carboxylic acids, sulfonic acids or phosphonic acids.

Preferred washing or cleaning compositions, especially preferred machine dishwasher detergents, are characterized in that they comprise a polymer a) which contains monomer units of the formula R¹R²C═CR³R⁴ in which each R¹, R², R³, R⁴ radical is independently selected from hydrogen, derivatized hydroxyl group, C₁₋₃₀ linear or branched alkyl groups, aryl, aryl-substituted C₁₋₃₀ linear or branched alkyl groups, polyalkoxylated alkyl groups, heteroaromatic organic groups having at least one positive charge without charged nitrogen, at least one quaternized nitrogen atom or at least one amino group having a positive charge in the partial region of the pH range from 2 to 11, or salts thereof, with the proviso that at least one R¹, R², R³, R⁴ radical is a heteroatomic organic group having at least one positive charge without charged nitrogen, at least one quaternized nitrogen atom or at least one amino group having a positive charge.

Cationic or amphoteric polymers particularly preferred in the context of the present application contain, as a monomer unit, a compound of the general formula

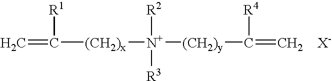

in which R¹ and R⁴ are each independently H or a linear or branched hydrocarbon radical having from 1 to 6 carbon atoms; R² and R³ are each independently an alkyl, hydroxyalkyl or aminoalkyl group in which the alkyl radical is linear or branched and has between 1 and 6 carbon atoms, which is preferably a methyl group; x and y are each independently integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate or mixtures thereof.

Preferred R¹ and R⁴ radicals in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂CH(OH)—CH₃, —CH(OH)—CH₂—CH₃, and —(CH₂CH₂—O)ₙH.

Very particular preference is given to polymers which have a cationic monomer unit of the above general formula in which R¹ and R⁴ are each H, R² and R³ are each methyl and x and y are each 1. The corresponding monomer units of the formula

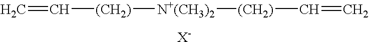

are, in the case that X⁻=chloride, also referred to as DADMAC (diallyldimethylammonium chloride).

Further particularly preferred cationic or amphoteric polymers contain a monomer unit of the general formula

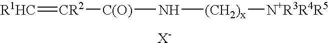

in which R¹, R², R³, R⁴ and R⁵ are each independently a linear or branched, saturated or unsaturated alkyl or hydroxyalkyl radical having from 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂CH(OH)—CH₃, —CH(OH)—CH₂—CH₃, and —(CH₂CH₂—O)ₙH, and x is an integer between 1 and 6.

Very particular preference is given in the context of the present application to polymers which have a cationic monomer unit of the above general formula in which R¹ is H and R², R³, R⁴ and R⁵ are each methyl and x is 3. The corresponding monomer units of the formula

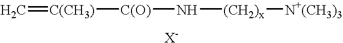

are, in the case that X⁻=chloride, also referred to as MAPTAC (methacrylamidopropyltrimethylammonium chloride).

Preference is given in accordance with the invention to using polymers which contain, as monomer units, diallyldimethylammonium salts and/or acrylamidopropyltrimethylammonium salts.

The aforementioned amphoteric polymers have not only cationic groups but also anionic groups or monomer units. Such anionic monomer units stem, for example, from the group of the linear or branched, saturated or unsaturated carboxylates, the linear or branched, saturated or unsaturated phosphonates, the linear or branched, saturated or unsaturated sulfates or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid and derivatives thereof, the allylsulfonic acids, for example allyloxybenzenesulfonic acid and methallylsulfonic acid, or the allylphosphonic acids.

Preferred usable amphoteric polymers stem from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl (meth)acrylic acid copolymers, the alkylacrylamide/alkyl methacrylate/alkyl-aminoethyl methacrylate/alkyl methacrylate copolymers, and the copolymers formed from unsaturated carboxylic acids, cationically derivatized unsaturated carboxylic acids and optionally further ionic or nonionic monomers.

Zwitterionic polymers usable with preference stem from the group of the acrylamidoalkyltrialkylammonium chloride/acrylic acid copolymers and their alkali metal and ammonium salts, the acrylamidoalkyltrialkylammonium chloride/methacrylic acid copolymers and their alkali metal and ammonium salts, and the methacryloylethylbetaine/methacrylate copolymers.

Preference is further given to amphoteric polymers which, in addition to one or more anionic monomers, comprise, as cationic monomers, methacrylamidoalkyltrialkylammonium chloride and dimethyl(diallyl)-ammonium chloride.

Particularly preferred amphoteric polymers stem from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers and the methacrylamidoalkyltrialkylammonium chloride/dimethyl(diallyl)ammonium chloride/alkyl(meth)acrylic acid copolymers and their alkali metal and ammonium salts.

Especially preferred are amphoteric polymers from the group of the methacrylamidopropyltrimethylammonium chloride/dimethyl(diallyl)ammonium chloride/acrylic acid copolymers, the methacrylamidopropyl-trimethylammonium chloride/dimethyl(diallyl)ammonium chloride/acrylic acid copolymers and the methacrylamidopropyltrimethylammonium chloride/dimethyl(diallyl)ammonium chloride/alkyl(meth)acrylic acid copolymers and their alkali metal and ammonium salts.

In a particularly preferred embodiment of the present invention, the polymers are present in prefinished form. Suitable means of finishing the polymers include
the encapsulation of the polymers by means of water-soluble or water-dispersible coating compositions, preferably by means of water-soluble or water-dispersible natural or synthetic polymers;
the encapsulation of the polymers by means of water-insoluble, meltable coating compositions, preferably by means of water-insoluble coating compositions from the groups of the waxes or paraffins having a melting point above 30° C.;
the cogranulation of the polymers with inert support materials, preferably with support materials from the group of the washing- or cleaning-active substances, more preferably from the group of the builders or cobuilders.

Washing or cleaning compositions comprise the aforementioned cationic and/or amphoteric polymers preferably in amounts of between 0.01 and 10% by weight, based in each case on the total weight of the washing or cleaning composition. However, preference is given in the context of the present application to those washing or cleaning compositions in which the proportion by weight of the cationic and/or amphoteric polymers is between 0.01 and 8% by weight, preferably between 0.01 and 6% by weight, preferentially between 0.01 and 4% by weight, more preferably between 0.01 and 2% by weight and in particular between 0.01 and 1% by weight, based in each case on the total weight of the machine dishwasher detergent.

Polymers effective as softeners are, for example, the polymers containing sulfonic acid groups, which are used with particular preference.

Polymers which contain sulfonic acid groups and can be used with particular preference are copolymers of unsaturated carboxylic acids, monomers containing sulfonic acid groups and optionally further ionic or nonionic monomers.

In the context of the present invention, preference is given, as a monomer, to unsaturated carboxylic acids of the formula

R¹(R²)C═C(R³)COOH

in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals substituted by —NH₂, —OH or —COOH, or are —COOH or —COOR⁴ where R⁴ is a saturated or unsaturated, straight-chain or branched hydrocarbon radical having from 1 to 12 carbon atoms.

Among the unsaturated carboxylic acids which can be described by the formula above, preference is given in particular to acrylic acid (R¹=R²=R³=H), methacrylic acid (R¹=R²=H; R³=CH₃) and/or maleic acid (R¹=COOH; R²=R³=H).

The monomers containing sulfonic acid groups are preferably those of the formula

R⁵(R⁶)C═C(R⁷)—X—SO₃H

in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Among these monomers, preference is given to those of the formulae

H₂C═CH—X—SO₃H

H₂C═C(CH₃)—X—SO₃H

HO₃S—X—(R⁶)C═C(R⁷)—X—SO₃H

in which R⁵ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and water-soluble salts of the acids mentioned.

Useful further ionic or nonionic monomers are in particular ethylenically unsaturated compounds. The content of these further ionic or nonionic monomers in the polymers used is preferably less than 20% by weight, based on the polymer. Polymers to be used with particular preference consist only of monomers of the formula R¹(R²)C═C(R³)COOH and of monomers of the formula R⁵(R⁶)C═C(R⁷)—X—SO₃H.

Further particularly preferred copolymers consist of
i) one or more unsaturated carboxylic acids from the group of acrylic acid, methacrylic acid and/or maleic acid,
ii) one or more monomers containing sulfonic acid groups of the formulae:

H₂C═CH—X—SO₃H

H₂C═C(CH₃)—X—SO₃H

HO₃S—X—(R⁶)C═C(R⁷)—X—SO₃H
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionic monomers.

The copolymers may contain the monomers from groups i) and ii) and optionally iii) in varying amounts, and it is possible to combine any of the representatives from group i) with any of the representatives from group ii) and any of the representatives from group iii). Particularly preferred polymers have certain structural units which are described below.

Thus, preference is given, for example, to copolymers which contain structural units of the formula

—[CH₂—CHCOOH]ₘ—[CH₂—CHC(O)—Y—SO₃H]ₚ—

in which m and p are each a whole natural number between 1 and 2000, and Y is a spacer group which is selected from substituted or unsubstituted, aliphatic, aromatic or substituted aromatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which is likewise preferred. The corresponding copolymers contain structural units of the formula

—[CH₂—C(CH₃)COOH]ₘ—[CH₂—CHC(O)—Y—SO₃H]ₚ—

in which m and p are each a whole natural number between 1 and 2000, and Y is a spacer group which is selected from substituted or unsubstituted, aliphatic, aromatic or substituted aromatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Acrylic acid and/or methacrylic acid can also be copolymerized entirely analogously with methacrylic acid derivatives containing sulfonic acid groups, which changes the structural units within the molecule. Thus, copolymers which contain structural units of the formula

—[CH₂—CHCOOH]ₘ—[CH₂—C(CH₃)C(O)—Y—SO₃H]ₚ—

in which m and p are each a whole natural number between 1 and 2000, and Y is a spacer group which is selected from substituted or unsubstituted, aliphatic, aromatic or substituted aromatic hydrocarbon radicals having from 1 to 24 carbon atoms, where spacer groups in which Y is —O—(CH₂)ₙ— where n=from 0 to 4, is —O—(C₆H₄)—, is —NH—C(CH₃)₂— or is —NH—CH(CH₂CH₃)—, are just as preferred as copolymers which contain structural units of the formula

—[CH₂—C(CH₃)COOH]ₘ—[CH₂—C(CH₃)C(O)—Y—SO₃H]ₚ—

in which m and p are each a whole natural number between 1 and 2000, and Y is a spacer group which is selected from substituted or unsubstituted, aliphatic, aromatic or substituted aromatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Instead of acrylic acid and/or methacrylic acid, or in addition thereto, it is also possible to use maleic acid as a particularly preferred monomer from group i). This leads to copolymers which are preferred in accordance with the invention and contain structural units of the formula

—[HOOCCH—CHCOOH]ₘ—[CH₂—CHC(O)—Y—SO₃H]ₚ—

in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—. Preference is further given in accordance with the invention to copolymers which contain structural units of the formula

—[HOOCCH—CHCOOH]ₘ—[CH₂—C(CH₃)C(O)O—Y—SO₃H]ₚ—

in which m and p are each a whole natural number between 1 and 2000, and Y is a spacer group which is selected from substituted or unsubstituted, aliphatic, aromatic or substituted aromatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In the polymers, all or some of the sulfonic acid groups may be in neutralized form, i.e. the acidic hydrogen atom of the sulfonic acid group may be replaced in some or all of the sulfonic acid groups by metal ions, preferably alkali metal ions and in particular by sodium ions. The use of copolymers containing partially or completely neutralized sulfonic acid groups is preferred in accordance with the invention.

The monomer distribution of the copolymers used with preference in accordance with the invention is, in the case of copolymers which contain only monomers from groups i) and ii), preferably in each case from 5 to 95% by weight of i) or ii), more preferably from 50 to 90% by weight of monomer from group i) and from 10 to 50% by weight of monomer from group ii), based in each case on the polymer.

In the case of terpolymers, particular preference is given to those which contain from 20 to 85% by weight of monomer from group i), from 10 to 60% by weight of monomer from group ii), and from 5 to 30% by weight of monomer from group iii).

The molar mass of the sulfo copolymers used with preference in accordance with the invention can be varied in order to adapt the properties of the polymers to the desired end use. Preferred washing or cleaning compositions are characterized in that the copolymers have molar masses of from 2000 to 200 000 gmol⁻¹, preferably from 4000 to 25 000 gmol⁻¹ and in particular from 5000 to 15 000 gmol⁻¹.

The bleaches are a washing- or cleaning-active substance used with particular preference. Among the compounds which serve as bleaches and supply H₂O₂ in water, sodium percarbonate, sodium perborate tetrahydrate and sodium perborate monohydrate are of particular significance. Further bleaches which can be used are, for example, peroxypyrophosphates, citrate perhydrates, and H₂O₂-supplying peracidic salts or peracids, such as perbenzoates, peroxophthalates, diperazelaic acid, phthaloimino peracid or diperdodecanedioic acid.

It is also possible to use bleaches from the group of the organic bleaches. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are (a) the peroxybenzoic acid and ring-substituted derivatives thereof, such as alkylperoxybenzoic acids, but it is also possible to use peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid).

The bleaches used may also be substances which release chlorine or bromine. Among suitable chlorine- or bromine-releasing materials, useful examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

According to the invention, preference is given to washing or cleaning compositions, especially machine dishwasher detergents, which contain from 1 to 35% by weight, preferably from 2.5 to 30% by weight, more preferably from 3.5 to 20% by weight and in particular from 5 to 15% by weight of bleach, preferably sodium percarbonate.

The active oxygen content of the washing or cleaning compositions, especially machine dishwasher detergents, is, based in each case on the total weight of the composition, preferably between 0.4 and 10% by weight, more preferably between 0.5 and 8% by weight and in particular between 0.6 and 5% by weight. Particularly preferred compositions have an active oxygen content above 0.3% by weight, preferably above 0.7% by weight, more preferably above 0.8% by weight and in particular above 1.0% by weight.

Bleach activators are used, for example, in washing or cleaning compositions, in order to achieve improved bleaching action when cleaning at temperatures of 60° C. and below. Bleach activators which may be used are compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetra-acetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoyl-succinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran, N-methylmorpholinioacetonitrile methylsulfate (MMA), and also acetylated sorbitol and mannitol or mixtures thereof (SORMAN), acylated sugar derivatives, in particular pentaacetylglucose (PAG), pentaacetylfructose, tetra-acetylxylose and octaacetyllactose, and acetylated, optionally N-alkylated, glucamine and gluconolactone, and/or N-acylated lactams, for example N-benzoylcaprolactam. Hydrophilically substituted acylacetals and acyllactams are likewise used with preference. Combinations of conventional bleach activators can also be used.

These bleach activators are used preferably in amounts up to 10% by weight, in particular from 0.1% by weight to 8% by weight, particularly from 2 to 8% by weight and more preferably from 2 to 6% by weight, based in each case on the total weight of the composition containing bleach activator.

Further bleach activators used with preference in the context of the present application are compounds from the group of the cationic nitriles, especially cationic nitriles of the formula

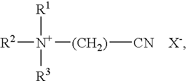

in which R¹ is —H, —CH₃, a C₂₋₂₄-alkyl or -alkenyl radical, a substituted C₂₋₂₄-alkyl or -alkenyl radical having at least one substituent from the group of —Cl, —Br, —OH, —NH₂, —CN, an alkyl- or alkenylaryl radical having a C₁₋₂₄-alkyl group, or is a substituted alkyl- or alkenylaryl radical having a C₁₋₂₄-alkyl group and at least one further substituent on the aromatic ring, R² and R³ are each independently selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂—CH₂—O)ₙH where n=1, 2, 3, 4, 5 or 6, and X is an anion.

Particular preference is given to a cationic nitrile of the formula

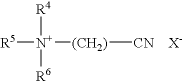

in which R⁴, R⁵ and R⁶ are each independently selected from —CH₃, —CH₂—CH₃, —CH₂—CH₂—CH₃, —CH(CH₃)—CH₃, where R⁴ may additionally also be —H, and X is an anion, it being preferred that R⁵=R⁶=—CH₃ and in particular R⁴=R⁵=R⁶=—CH₃, and particular preference being given to compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻ or (HO—CH₂—CH₂)₃N⁽⁺⁾CH₂—CN X⁻, particular preference being given in turn, from this group of substances, to the cationic nitrile of the formula (CH₃)₃N⁽⁺⁾CH₂—CN X⁻ in which X⁻ is an anion which is selected from the group of chloride, bromide, iodide, hydrogensulfate, methosulfate, p-toluenesulfonate (tosylate) or xylenesulfonate.

In addition to the conventional bleach activators, or instead of them, it is also possible to use so-called bleach catalysts. These substances are bleach-boosting transition metal salts or transition metal complexes, for example salen or carbonyl complexes of Mn, Fe, Co, Ru or Mo. It is also possible to use complexes of Mn, Fe, Co, Ru, Mo, Ti, V and Cu with N-containing tripod ligands, and also Co-, Fe-, Cu- and Ru-amine complexes as bleach catalysts.

Bleach-boosting transition metal complexes, in particular with the central atoms Mn, Fe, Co, Cu, Mo, V, Ti and/or Ru, preferably selected from the group of manganese and/or cobalt salts and/or complexes, more preferably the cobalt (ammine) complexes, the cobalt (acetate) complexes, the cobalt (carbonyl) complexes, the chlorides of cobalt or manganese, and manganese sulfate, are used in customary amounts, preferably in an amount up to 5% by weight, in particular from 0.0025% by weight to 1% by weight and more preferably from 0.01% by weight to 0.25% by weight, based in each case on the total weight of the composition containing bleach activator. In specific cases, though, it is also possible to use a greater amount of bleach activator.

With particular preference, complexes of manganese in the II, III, IV or IV oxidation states are used, which preferably contain one or more macrocyclic ligand(s) with the donor functions N, NR, PR, O and/or S. Preference is given to using ligands which have nitrogen donor functions. Particular preference is given to using bleach catalyst(s) in the inventive compositions which comprise, as macromolecular ligands, 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes are, for example, [Mn^{III}₂(μ-O)₁ (μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(—O)₁(∥-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂(OAc=OC(O)CH₃).

To enhance the washing or cleaning performance of washing or cleaning compositions, it is possible to use enzymes. These include in particular proteases, amylases, lipases, hemicellulases, cellulases or oxidoreductases, and preferably mixtures thereof. These enzymes are in principle of natural origin; starting from the natural molecules, improved variants are available for use in washing and cleaning compositions and are preferably used accordingly. Washing or cleaning compositions preferably contain enzymes in total amounts of from 1×10⁻⁶ to 5% by weight based on active protein. The protein concentration may be determined with the aid of known methods, for example the BCA method or the biuret method.

Among the proteases, preference is given to those of the subtilisin type. Examples thereof include the subtilisins BPN′ and Carlsberg and their further-developed forms, protease PB92, the subtilisins 147 and 309, Bacillus lentus alkaline protease, subtilisin DY and the enzymes thermitase and proteinase K which can be classified to the subtilases but not to the subtilisins in the narrower sense, and the proteases TW3 and TW7.

Examples of amylases which can be used in accordance with the invention are the α-amylases from Bacillus licheniformis, from B. amyloliquefaciens, from B. stearothermophilus, from Aspergillus niger and A. oryzae and developments of the aforementioned amylases which have been improved for use in washing and cleaning compositions. Enzymes which should additionally be emphasized for this purpose are the α-amylase from Bacillus sp. A 7-7 (DSM 12368), and the cyclodextrin glucanotransferase (CGTase) from B. agaradherens (DSM 9948).

In addition, lipases or cutinases can be used in accordance with the invention, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. It is additionally possible, for example, to use the cutinases which have originally been isolated from Fusarium solani pisi and Humicola insolens. Also usable are lipases and cutinases whose starting enzymes have originally been isolated from Pseudomonas mendocina and Fusarium solanii.

It is also possible to use enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases.

Particular preference is given to using perhydrolases in the inventive compositions.

To enhance the bleaching action, it is possible in accordance with the invention to use oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Advantageously, preferably organic, more preferably aromatic, compounds which interact with the enzymes are additionally added in order to enhance the activity of the oxidoreductases concerned (enhancers), or to ensure the electron flux in the event of large differences in the redox potentials between the oxidizing enzymes and the stains (mediators).

The enzymes may be used in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated either for the solid or for the liquid administration form, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impervious protective layer. It is possible in layers applied thereto to additionally apply further active ingredients, for example stabilizers, emulsifiers, pigments, bleaches or dyes. Such capsules are applied by methods known per se, for example by agitated or roll granulation or in fluidized bed processes. Advantageously, such granules, for example as a result of application of polymeric film formers, are low-dusting and storage-stable owing to the coating.

It is also possible to formulate two or more enzymes together, so that a single granule has a plurality of enzyme activities.

A protein and/or enzyme may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, washing or cleaning compositions may comprise stabilizers; the provision of such compositions constitutes a preferred embodiment of the present invention.

Preference is given to using one or more enzymes and/or enzyme preparations, preferably solid protease preparations and/or amylase preparations, in amounts of from 0.1 to 5% by weight, preferably of from 0.2 to 4.5% by weight and in particular from 0.4 to 4% by weight, based in each case on the overall composition containing enzyme.

Glass corrosion inhibitors prevent the occurrence of cloudiness, smears and scratches, but also the iridescence of the glass surface of machine-cleaned glasses. Preferred glass corrosion inhibitors stem from the group of the magnesium and/or zinc salts and/or magnesium and/or zinc complexes.

The spectrum of the zinc salts, preferred in accordance with the invention, preferably of organic acids, more preferably of organic carboxylic acids, ranges from salts which are sparingly soluble or insoluble in water, i.e. have a solubility below 100 mg/l, preferably below 10 mg/l, in particular below 0.01 mg/l, to those salts which have a solubility in water above 100 mg/l, preferably above 500 mg/l, more preferably above 1 g/l and in particular above 5 g/l (all solubilities at water temperature 20° C.). The first group of zinc salts includes, for example, zinc citrate, zinc oleate and zinc stearate; the group of soluble zinc salts includes, for example, zinc formate, zinc acetate, zinc lactate and zinc gluconate.

With particular preference, the glass corrosion inhibitor used is at least one zinc salt of an organic carboxylic acid, more preferably a zinc salt from the group of zinc stearate, zinc oleate, zinc gluconate, zinc acetate, zinc lactate and/or zinc citrate. Preference is also given to zinc ricinoleate, zinc abietate and zinc oxalate.

In the context of the present invention, the content of zinc salt in washing or cleaning compositions is preferably between 0.1 and 5% by weight, preferably between 0.2 and 4% by weight and in particular between 0.4 and 3% by weight, or the content of zinc in oxidized form (calculated as Zn²⁺) is between 0.01 and 1% by weight, preferably between 0.02 and 0.5% by weight and in particular between 0.04 and 0.2% by weight, based in each case on the total weight of the composition containing glass corrosion inhibitor.

Corrosion inhibitors serve to protect the ware or the machine, particularly silver care agents having particular significance in the field of machine dishwashing. It is possible to use the known substances from the prior art. In general, it is possible in particular to use silver care agents selected from the group of the triazoles, the benzotriazoles, the bisbenzotriazoles, the aminotriazoles, the alkylaminotriazoles and the transition metal salts or complexes. Particular preference is given to using benzotriazole and/or alkylaminotriazole. Preferably in accordance with the invention, 3-amino-5-alkyl-1,2,4-triazoles or their physiologically compatible salts are used, particular preference being given to using these substances in a concentration of from 0.001 to 10% by weight, preferably from 0.0025 to 2% by weight, more preferably from 0.01 to 0.04% by weight. Preferred acids for the salt formation are hydrochloric acid, sulfuric acid, phosphoric acid, carbonic acid, sulfurous acid, organic carboxylic acids such as acetic acid, glycolic acid, citric acid, succinic acid. Very particularly effective are 5-pentyl-, 5-heptyl-, 5-nonyl-, 5-undecyl-, 5-isononyl-, 5-Versatic-10 acid alkyl-3-amino-1,2,4-triazoles, and also mixtures of these substances.

Frequently also found in cleaning formulations are active chlorine-containing agents which can significantly reduce the corrosion of the silver surface. In chlorine-free cleaners, particularly oxygen- and nitrogen-containing organic redox-active compounds are used, such as di- and trihydric phenols, for example hydroquinone, pyrocatechol, hydroxyhydroquinone, gallic acid, phloroglucinol, pyrogallol and derivatives of these classes of compound. Salt- and complex-type inorganic compounds, such as salts of the metals Mn, Ti, Zr, Hf, V, Co and Ce, also frequently find use. Preference is given in this context to the transition metal salts which are selected from the group of manganese and/or cobalt salts and/or complexes, more preferably cobalt (ammine) complexes, cobalt (acetate) complexes, cobalt (carbonyl) complexes, the chlorides of cobalt or manganese, and manganese sulfate. Zinc compounds may likewise be used to prevent corrosion on the ware.

Instead of or in addition to the above-described silver care agents, for example the benzotriazoles, it is possible to use redox-active substances. These substances are preferably inorganic redox-active substances from the group of the manganese, titanium, zirconium, hafnium, vanadium, cobalt and cerium salts and/or complexes, the metals preferably being in one of the oxidation states II, III, IV, V or VI.

The metal salts or metal complexes used should be at least partially soluble in water. The counterions suitable for the salt formation include all customary singly, doubly or triply negatively charged inorganic anions, for example oxide, sulfate, nitrate, fluoride, but also organic anions, for example stearate.

Particularly preferred metal salts and/or metal complexes are selected from the group of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃, and mixtures thereof, so that the metal salts and/or metal complexes selected from the group of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are used with particular preference.

The inorganic redox-active substances, especially metal salts or metal complexes, are preferably coated, i.e. covered completely with a material which is water-tight, but slightly soluble at the cleaning temperatures, in order to prevent their premature disintegration or oxidation in the course of storage. Preferred coating materials which are applied by known methods, for instance by the melt coating method according to Sandwik from the foods industry, are paraffins, micro waxes, waxes of natural origin, such as carnauba wax, candelilla wax, beeswax, relatively high-melting alcohols, for example hexadecanol, soaps or fatty acids.

The metal salts and/or metal complexes mentioned are present in cleaning compositions preferably in an amount of from 0.05 to 6% by weight, preferably from 0.2 to 2.5% by weight, based in each case on the overall composition.

When a film pouch comprises a free-flowing medium in the form of granules, it is preferred that they comprise disintegration assistants, also known as tablet disintegrants. Tablet disintegrants or disintegration accelerants are understood to mean assistants which ensure the rapid decomposition of tablets in water or other media and the release of active ingredients.

These substances, which are also referred to as “breakup” agents owing to their action, increase their volume on ingress of water, and it is either the increase in the intrinsic volume (swelling) or the release of gases that can generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and derivatives thereof, alginates or casein derivatives.

Preference is given to using disintegration assistants in amounts of from 0.5 to 10% by weight, preferably from 3 to 7% by weight and in particular from 4 to 6% by weight, based in each case on the total weight of the composition comprising disintegration assistant.

The preferred disintegration assistants used are disintegration assistants based on cellulose, so that preferred washing and cleaning compositions contain such a cellulose-based disintegration assistant in amounts of from 0.5 to 10% by weight, preferably from 3 to 7% by weight and in particular from 4 to 6% by weight. Pure cellulose has the formal empirical composition (C₆H₁₀O₅)ₙ and, viewed in a formal sense, is a β-1,4-polyacetal of cellobiose which is in turn formed from two molecules of glucose. Suitable celluloses consist of from approx. 500 to 5000 glucose units and accordingly have average molar masses of from 50 000 to 500 000. Useful cellulose-based disintegration assistants in the context of the present invention are also cellulose derivatives which are obtainable by polymer-like reactions from cellulose. Such chemically modified celluloses comprise, for example, products of esterifications and etherifications in which hydroxyl hydrogen atoms have been substituted. However, celluloses in which the hydroxyl groups have been replaced by functional groups which are not bonded via an oxygen atom can also be used as cellulose derivatives. The group of the cellulose derivatives includes, for example, alkali metal celluloses, carboxymethylcellulose (CMC), cellulose esters and ethers, and amino celluloses. The cellulose derivatives mentioned are preferably not used alone as disintegration assistants based on cellulose, but rather in a mixture with cellulose. The content of cellulose derivatives in these mixtures is preferably below 50% by weight, more preferably below 20% by weight, based on the disintegration assistant based on cellulose. The disintegration assistant based on cellulose which is used is more preferably pure cellulose which is free of cellulose derivatives.

The cellulose used as a disintegration assistant is preferably not used in finely divided form, but rather converted to a coarser form before admixing with the premixtures to be compressed, for example granulated or compacted. The particle sizes of such disintegration assistants are usually above 200 μm, preferably to an extent of at least 90% by weight between 300 and 1600 μm and in particular to an extent of at least 90% by weight between 400 and 1200 μm.

As a further cellulose-based disintegration assistant or as a constituent of this component, it is possible to use microcrystalline cellulose. This microcrystalline cellulose is obtained by partial hydrolysis of celluloses under conditions which attack and fully dissolve only the amorphous regions (approx. 30% of the total cellulose mass) of the celluloses, but leave the crystalline regions (approx. 70%) undamaged. A subsequent deaggregation of the microfine celluloses formed by the hydrolysis affords the microcrystalline celluloses which have primary particle sizes of approx. 5 μm and can be compacted, for example, to granules having an average particle size of 200 μm.

Preferred disintegration assistants, preferably a cellulose-based disintegration assistant, preferably in granulated, cogranulated or compacted form, are present in the compositions containing disintegration assistant in amounts of from 0.5 to 10% by weight, preferably from 3 to 7% by weight and in particular from 4 to 6% by weight, based in each case on the total weight of the composition containing disintegration assistant.

According to the invention, gas-evolving effervescent systems may preferably additionally be used as tablet disintegration assistants. The gas-evolving effervescent system may consist of a single substance which releases a gas on contact with water. Among these compounds, mention should be made of magnesium peroxide in particular, which releases oxygen on contact with water. Typically, however, the gas-releasing effervescent system itself consists of at least two constituents which react with one another to form gas. While a multitude of systems which release, for example, nitrogen, oxygen or hydrogen are conceivable and practicable here, the effervescent system used in the washing and cleaning compositions will be selectable on the basis of both economic and on the basis of environmental considerations. Preferred effervescent systems consist of alkali metal carbonate and/or alkali metal hydrogencarbonate and of an acidifier which is suitable for releasing carbon dioxide from the alkali metal salts in aqueous solution.

Acidifiers which release carbon dioxide from the alkali metal salts in aqueous solution and can be used are, for example, boric acid and also alkali metal hydrogensulfates, alkali metal dihydrogenphosphates and other inorganic salts. Preference is given, however, to the use of organic acidifiers, citric acid being a particularly preferred acidifier. Preference is given to acidifiers in the effervescent system from the group of the organic di-, tri- and oligocarboxylic acids, or mixtures of these.

In the context of the present invention, the perfume oils and/or fragrances used may be individual odorant compounds, for example the synthetic products of the ester, ether, aldehyde, ketone, alcohol and hydrocarbon type. However, preference is given to using mixtures of different odorants which together produce a pleasant fragrance note. Such perfume oils may also comprise natural odorant mixtures, as obtainable from plant sources, for example pine oil, citrus oil, jasmine oil, patchouli oil, rose oil or ylang-ylang oil.

In order to be perceptible, an odorant must be volatile, for which an important role is played not only by the nature of the functional groups and by the structure of the chemical compound but also by the molar mass. Thus, the majority of odorants have molar masses of up to about 200 daltons, while molar masses of 300 daltons or more tend to be an exception. On the basis of the different volatility of odorants there is a change in the odor of a perfume or fragrance composed of two or more odorants during its evaporation, and the perceived odors are divided into top note, middle note or body, and end note or dry out. Since the perception of odor is to a large extent also based on the odor intensity, the top note of a perfume or fragrance does not consist only of volatile compounds, whereas the end note consists for the most part of less volatile odorants, i.e. odorants which adhere firmly. In the composition of perfumes it is possible for more volatile odorants, for example, to be bound to certain fixatives, which prevent them from evaporating too rapidly. The subsequent classification of the odorants into “more volatile” and “firmly adhering” odorants, therefore, states nothing about the perceived odor and about whether the odorant in question is perceived as a top note or as a middle note.

The fragrances can be processed directly, but it may also be advantageous to apply the fragrances to carriers which ensure long-lasting fragrance by slower fragrance release. Useful such carrier materials have been found to be, for example, cyclodextrins, and the cyclodextrin-perfume complexes may additionally also be coated with further assistants.

Preferred dyes, whose selection presents no difficulty at all to the person skilled in the art, have high storage stability and insensitivity toward the other ingredients of the compositions and to light, and also have no pronounced substantivity toward the substrates to be treated with the dye-containing compositions, such as textiles, glass, ceramic or plastic dishware, so as not to stain them.

In the selection of the colorant, it has to be ensured that the colorants have a high storage stability and insensitivity toward light. At the same time, it should be taken into account when selecting suitable colorants that colorants have different stabilities toward oxidation. It is generally the case that water-insoluble colorants are more stable toward oxidation than water-soluble colorants. The concentration of the colorant in the washing or cleaning compositions varies depending on the solubility and hence also upon the oxidation sensitivity. In the case of highly water-soluble colorants, typical colorant concentrations in the range from a few 10⁻² to 10⁻³% by weight are selected. In the case of the pigmentary dyes, which are especially preferred owing to their brilliance but are less readily water-soluble, the suitable concentration of the colorant in washing or cleaning compositions, in contrast, is typically a few 10⁻³ to 10⁻⁴% by weight.

Preference is given to colorants which can be destroyed oxidatively in the washing process, and to mixtures thereof with suitable blue dyes, known as bluing agents. It has been found to be advantageous to use colorants which are soluble in water or, at room temperature, in liquid organic substances. Examples of suitable colorants are anionic colorants, for example anionic nitroso dyes.

In addition to the components described in detail so far, the washing and cleaning compositions may comprise further ingredients which further improve the performance and/or esthetic properties of these compositions. Preferred compositions comprise one or more substances from the group of electrolytes, pH modifiers, fluorescers, hydrotropes, foam inhibitors, silicone oils, antiredeposition agents, optical brighteners, graying inhibitors, shrinkproofing agents, creaseproofing agents, dye transfer inhibitors, active antimicrobial ingredients, germicides, fungicides, antioxidants, antistats, ironing aids, repellency and impregnation agents, antiswell and antislip agents and UV absorbers.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl₂ in the washing, or cleaning compositions.

In order to bring the pH of the washing or cleaning compositions into the desired range, it may be appropriate to use pH modifiers. It is possible here to use all known acids or alkalis, as long as their use is not forbidden on performance or ecological grounds or on grounds of consumer protection. Typically, the amount of these modifiers does not exceed 1% by weight of the overall formulation.

Useful foam inhibitors include soaps, oils, fats, paraffins or silicone oils, which may optionally be applied to support materials. Suitable support materials are, for example, inorganic salts such as carbonates or sulfates, cellulose derivatives or silicates and mixtures of the aforementioned materials. Compositions which are preferred in the context of the present application comprise paraffins, preferably unbranched paraffins (n-paraffins) and/or silicones, preferably linear polymeric silicones which have the composition according to the scheme (R₂SiO)ₓ and are also referred to as silicone oils. These silicone oils are commonly clear, colorless, neutral, odorless, hydrophobic liquids having a molecular weight between 1000 and 150 000, and viscosities between 10 and 1 000 000 mPa·s.

Suitable antiredeposition agents, which are also referred to as soil repellents, are, for example, nonionic cellulose ethers, such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Among these, particular preference is given to the sulfonated derivatives of phthalic acid polymers and terephthalic acid polymers.

Optical brighteners (known as “whiteners”) may be added to the washing or cleaning compositions in order to eliminate graying and yellowing of the treated textiles. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors are cellulose ethers such as carboxymethylcellulose (sodium salt), methylcellulose, hydroxyalkylcellulose and mixed ethers such as methylhydroxyethylcellulose, methylhydroxypropylcellulose, methylcarboxy-methylcellulose and mixtures thereof.

Since textile fabrics, in particular those made of rayon, viscose, cotton and mixtures thereof, can tend to crease because the individual fibers are sensitive toward bending, folding, compressing and crushing transverse to the fiber direction, synthetic creaseproofing agents may be used. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters.

Repellency and impregnation processes serve to finish textiles with substances which prevent the deposition of soil or make it easier to wash out. Preferred repellency and impregnating agents are perfluorinated fatty acids, also in the form of their aluminum and zirconium salts, organic silicates, silicones, polyacrylic esters having a perfluorinated alcohol component or polymerizable compounds having a coupled, perfluorinated acyl or sulfonyl radical. Antistats may also be present. The soil-repellent finish with repellency and impregnating agents is often classified as an easycare finish. The penetration of the impregnating agents in the form of solutions or emulsions of the active ingredients in question may be eased by adding wetting agents which lower the surface tension. A further field of use of repellency and impregnating agents is the water-repellent finishing of textiles, tents, tarpaulins, leather, etc., in which, in contrast to waterproofing, the fabric pores are not sealed and the substance thus remains breathable (hydrophobizing). The hydrophobizing agents used for the hydrophobization coat textiles, leather, paper, wood, etc., with a very thin layer of hydrophobic groups such as relatively long alkyl chains or siloxane groups. Suitable hydrophobizing agents are, for example, paraffins, waxes, metal soaps, etc., with additives of aluminum or zirconium salts, quaternary ammonium compounds having long-chain alkyl radicals, urea derivatives, fatty acid-modified melamine resins, chromium complex salts, silicones, organotin compounds and glutaraldehyde, and also perfluorinated compounds. The hydrophobized materials do not have a greasy feel; nevertheless water drops, similarly to the way they do on greased substances, run off them without wetting them. For example, silicone-impregnated textiles have a soft hand and are water- and soil-repellent; stains of ink, wine, fruit juices and the like can be removed more easily.

Active antimicrobial ingredients can be used to control microorganisms. A distinction is drawn here, depending on the antimicrobial spectrum and mechanism of action, between bacteriostats and bactericides, fungistats and fungicides, etc. Important substances from these groups are, for example, benzalkonium chlorides, alkylarylsulfonates, halophenols and phenylmercuric acetate, although it is also possible to dispense entirely with these compounds.

In order to prevent undesired changes, caused by the action of oxygen and other oxidative processes, to the washing and cleaning compositions and/or the textiles treated, the compositions may comprise antioxidants. This class of compound includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats. Antistats increase the surface conductivity and thus permit improved discharge of charges formed. External antistats are generally substances having at least one hydrophilic molecular ligand and impart to the surfaces a more or less hygroscopic film. These usually interface-active antistats can be subdivided into nitrogen antistats (amines, amides, quaternary ammonium compounds), phosphorus antistats (phosphoric esters) and sulfur antistats (alkylsulfonates, alkyl sulfates). Lauryl- (or stearyl) dimethylbenzylammonium chlorides are likewise suitable as antistats for textiles or as additives for washing compositions, in which case a softening effect is additionally achieved.

To improve the water-absorption capacity and the rewettability of the treated textiles, and to ease the ironing of these textiles, it is possible to use silicone derivatives. They additionally improve the rinse-out performance of the washing or cleaning compositions by virtue of their foam-inhibiting properties. Preferred silicone derivatives are, for example, polydialkyl- or alkylarylsiloxanes in which the alkyl groups have from one to five carbon atoms and are fully or partly fluorinated. Preferred silicones are polydimethylsiloxanes which may optionally be derivatized and are in that case amino-functional or quaternized or have Si—OH, Si—H and/or Si—Cl bonds. Further preferred silicones are the polyalkylene oxide-modified polysiloxanes, i.e. polysiloxanes which have polyethylene glycols, for example, and the polyalkylene oxide-modified dimethyl polysiloxanes.

Finally, it is also possible in accordance with the invention to use UV absorbers which attach to the treated textiles and improve the photoresistance of the fibers. Compounds which have these desired properties are, for example, the compounds and derivatives of benzophenone having substituents in the 2- and/or 4-position which are active by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid.

Owing to their fibercare action, protein hydrolyzates are further preferred active substances from the field of washing and cleaning compositions in the context of the present invention. Protein hydrolyzates are product mixtures which are obtained by acid-, base- or enzyme-catalyzed degradation of proteins. According to the invention, protein hydrolyzates either of vegetable or animal origin may be used. Animal protein hydrolyzates are, for example, elastin, collagen, keratin, silk and milk protein hydrolyzates which may also be present in the form of salts. Preference is given in accordance with the invention to the use of protein hydrolyzates of vegetable origin, for example soybean, almond, rice, pea, potato and wheat protein hydrolyzates. Although preference is given to the use of the protein hydrolyzates as such, it is in some cases also possible to use in their stead amino acid mixtures or individual amino acids obtained in other ways, for example arginine, lysine, histidine or pyroglutamic acid. It is likewise possible to use derivatives of protein hydrolyzates, for example in the form of their fatty acid condensates.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed or as needed to render such methods operative.

Changes in form and substitution of equivalents are contemplated as circumstances may suggest or render expedient. Although specific terms have been employed herein, such terms are intended in a descriptive sense and not for purposes of limitation.

1. A package for free-flowing media comprising a molded pulp vessel, the vessel partly or completely surrounding at least two film pouches or at least one film pouch having a plurality of chambers, wherein the pouches or chambers open through a single combined dosage closure or dosage tap.

2. The package of claim 1, wherein the film pouch having a plurality of chambers has n chambers and is filled with n, n−1 or n−2 different media, and n is 2, 3, 4 or 5.

3. The package of claim 1, wherein the molded pulp vessel partly or completely surrounds 2, 3, 4 or 5 film pouches.

4. The package of claim 1, wherein the molded pulp vessel comprises at least 50% by weight waste paper.

5. The package of claim 4, comprising at least 70% by weight waste paper.

6. The package of claim 5, comprising at least 90% by weight waste paper.

7. The package of claim 1, wherein each film pouch independently encloses a volume of 0.5 ml to 10 l.

8. The package of claim 7, wherein each film pouch independently encloses a volume of 100 ml to 2 l.

9. The package of claim 1, wherein all of the film packages enclose a total volume of 1 ml to 10 l.

10. The package of claim 9, wherein all of the film packages enclose a total volume of 100 ml to 5 l.

11. The package of claim 1, wherein the molded pulp vessel has a handle comprising molded pulp material or a handle comprising another material, said handle comprising another material being adhesive-bonded or riveted to the molded pulp vessel.

12. The package of claim 1, wherein the film pouch or pouches bond to an inner wall of the molded pulp vessel inner wall at one or more points.

13. The package of claim 12, wherein the bond is formed by an adhesive, latch, snap, plug, clamp, or rivet.

14. The package as claimed in claim 12, wherein one or more of the bonds of the film pouch or pouches to the molded pulp vessel inner wall are releasable.

15. The package of claim 1, wherein the film pouch or pouches surrounded by the molded pulp vessel are either not bonded or are bonded releasably to the molded pulp vessel inner wall, and one or more film pouches can be removed from the molded pulp vessel without destruction and reinserted into the molded pulp vessel.

16. The package of claim 15, wherein the molded pulp vessel is openable and closeable for removal or insertion of the one or more film pouches.

17. A process for making a package for a free-flowing material, comprising the steps of:
a. forming an open molded vessel from pulp material poured into a mold, dried, and solidified;
b. forming at least one film pouch having a plurality of chambers or forming a plurality of film pouches, wherein the chambers or pouches open through a single combined dosage closure or dosage tap;
c. inserting the film pouch or pouches into the open molded pulp vessel;
d. optionally bonding the pouch or pouches to an inner wall of the vessel at least one point by an adhesive, latch, snap, plug, clamp, or rivet, said bonding optionally being releasable; and
e. optionally sealing the molded pulp vessel.

18. The process of claim 17, further comprising the step of filling and sealing the film pouch or pouches before inserting the film pouch or pouches into the molded pulp vessel.

19. The process of claim 17, further comprising the step of filling and sealing the film pouch or pouches after inserting the film pouch or pouches into the molded pulp vessel.

20. The process of claim 17, further comprising the step of sealing the molded pulp vessel after the pouch or pouches have been filled and sealed.

21. The process of claim 17, further comprising the step of filling the film pouch or pouches through the single dosage closure or dosage tap after the molded pulp vessel has been sealed.

22. A process for producing a package for a free flowing material, comprising the steps of:
a. forming at least one film pouch having a plurality of chambers or forming a plurality of film pouches, wherein the chambers or pouches open through a single combined dosage closure or dosage tap;
b. filling and sealing the film pouch or pouches;
c. contacting the filled and sealed film pouch or pouches with a molded pulp material, whereby the film pouch or pouches are partly or completely covered with the molded pulp material; and
d. drying and solidifying the molded pulp material to form a molded pulp vessel that partly or completely surrounds the film pouch or pouches.

23. The package of claim 1, comprising a storage unit, transport unit, or dosage unit filled with a liquid washing, cleaning, or care composition.

24. The process of claim 17, further comprising the step of filling the pouch or pouches with a liquid washing, cleaning, or care composition.

25. The process of claim 22, wherein the filled package forms a storage unit, transport unit, or dosage unit filled with a liquid washing, cleaning, or care composition.
